(19) United States
(12) Patent Application Publication
(10) Pub. No.: US 2026/0333224 A1
(43) Pub. Date: Oct. 22, 2026

(54) LOW POWER RADIO INITIAL ACCESS WITH UPLINK WAKE-UP SIGNALS

(71) Applicant: Lenovo (United States) Inc., Morrisville, NC (US)

(72) Inventors: Karthikeyan Ganesan, Nauheim (DE); Ali Ramadan Ali, Kraiburg (DE); Ravi Kuchibhotla, Chicago, IL (US)

(73) Assignee: Lenovo (United States) Inc., Morrisville, NC (US)

(21) Appl. No.: 19/382,240

(22) Filed: Nov. 6, 2025

(51) Int. Cl. H04W 52/02; H04W 68/00; H04W 74/0833

(52) U.S. Cl. CPC H04W 52/0235; H04W 68/00; H04W 74/0833

(57) ABSTRACT

Various aspects of the present disclosure relate to low power radio initial access with uplink wake-up signals. A network entity (NE) includes a low power radio and a main power. The NE uses the low power radio to transmit, to a user equipment (UE) including a low power radio and a main radio, one or more synchronization signals and a first portion of minimum system information via a first carrier. In response, the UE transmits, to the NE, an uplink wake-up signal (UL WUS) associated with a public land mobile network of the NE. The UL WUS indicates a request for a second portion of minimum system information. The NE activates the main radio in response to receiving the UL WUS and transmits, using the main radio of the NE, the second portion of the minimum system information via a second carrier.

### TECHNICAL FIELD

The present disclosure relates to wireless communications, and more specifically to network energy savings and initial access procedures using low power radio configurations.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A NE for wireless communication is described. The NE may be configured to, capable of, or operable to perform one or more operations as described herein. For example, the NE may be configured to, capable of, or operable to include a low power radio, a main power radio, at least one memory, and at least one processor coupled with the at least one memory and operable to cause the NE to transmit, using the low power radio, one or more synchronization signals and a first portion of minimum system information via a first carrier; receive an uplink wake-up signal from a UE, where the uplink wake-up signal is associated with a public land mobile network (PLMN) of the NE; activate the main radio of the NE in response to receiving the uplink wake-up signal; and transmit, using the main radio, a second portion of the minimum system information via a second carrier.

A processor for wireless communication is described. The processor may be configured to, capable of, or operable to perform one or more operations as described herein. For example, the processor may be configured to, capable of, or operable to cause a network entity to transmit, using a low power radio, one or more synchronization signals and a first portion of minimum system information via a first carrier; receive an uplink wake-up signal from a UE, where the uplink wake-up signal is associated with a PLMN of the network entity; activate a main radio of the network entity in response to receiving the uplink wake-up signal; and transmit, using the main radio, a second portion of the minimum system information via a second carrier.

A method performed or performable by a NE for wireless communication is described. The method may include transmitting, using a low power radio, one or more synchronization signals and a first portion of minimum system information via a first carrier; receiving an uplink wake-up signal from a UE, where the uplink wake-up signal is associated with a PLMN of the NE; activating a main radio of the NE in response to receiving the uplink wake-up signal; and transmitting, using the main radio, a second portion of the minimum system information via a second carrier.

In some implementations of the NE, the processor, and the method described herein, the at least one processor may be further configured to cause the NE to transmit a configuration for the uplink wake-up signal together with cell selection information and cell access related information to restrict transmission of the wake-up signal to UEs associated with the PLMN of the NE. In some implementations of the NE, the processor, and the method described herein, the first and second carriers may be the same carrier configured for a network energy savings mode with reduced transmission frequency, where the at least one processor may be further configured to cause the NE to transmit, using the low power radio, at least one paging message during one or more LP-POs, where the one or more LP-POs are associated with the uplink wake-up signal, and receive, in response to the at least one paging message, a request for the second portion of the minimum system information, where the request for the second portion of the minimum system information is included in one of the uplink wake-up signal or a random access channel (RACH) message.

In some implementations of the NE, the processor, and the method described herein, the first carrier may be configured for periodic frequent common signal transmission and the second carrier may be configured for a network energy savings mode with reduced transmission frequency, where the at least one processor may be further configured to cause the NE to transmit, using the low power radio, at least one paging message via the second carrier during one or more LP-POs, and receive a RACH message via the first carrier based at least in part on the at least one paging message. In some implementations of the NE, the processor, and the method described herein, the uplink wake-up signal may be received via the second carrier and may indicate at least one of reselection of the UE to the second carrier or a request for the second portion of the minimum system information.

In some implementations of the NE, the processor, and the method described herein, the first carrier may be configured for a network energy savings mode with reduced transmission frequency and the second carrier may be configured for periodic frequent common signal transmission, where the at least one processor may be further configured to cause the NE to transmit, using the low power radio, at least one paging message via the second carrier during one or more LP-POs, and receive a RACH message via the second carrier based at least in part on the at least one paging message. In some implementations of the NE, the processor, and the method described herein, the first portion of minimum system information may include a plurality of information segments transmitted according to orthogonal sequence selection, where each information segment may have a respective transmission periodicity. In some implementations of the NE, the processor, and the method described herein, the plurality of information segments may include at least a first information segment including at least one of a cell barred indication, an SSB subcarrier offset parameter, or system frame number information, and a second information segment including at least one of cell selection information, cell access related information, or uplink wake-up signal configuration parameters.

In some implementations of the NE, the processor, and the method described herein, to transmit the one or more synchronization signals, the at least one processor may be further configured to cause the NE to transmit a first stage synchronization signal on a sparse frequency raster using the low power radio, and transmit a second stage synchronization signal using the main radio in response to the uplink wake-up signal. In some implementations of the NE, the processor, and the method described herein, the first stage synchronization signal may comprise a primary synchronization signal (PSS) and the second stage synchronization signal may comprise a secondary synchronization signal (SSS) and a physical broadcast channel (PBCH). In some implementations of the NE, the processor, and the method described herein, the first stage synchronization signal may indicate presence of the second stage synchronization signal and may use a sequence that indicates a cluster of frequency positions for monitoring the second stage synchronization signal, and the second stage synchronization signal may comprise a PSS, a SSS, and a PBCH. In some implementations of the NE, the processor, and the method described herein, the one or more synchronization signals may be scrambled with PLMN identification information using scrambling sequences derived from the PLMN identification information.

A UE for wireless communication is described. The UE may be configured to, capable of, or operable to perform one or more operations as described herein. For example, the UE may be configured to, capable of, or operable to include a low power radio, a main power radio, at least one memory, and at least one processor coupled with the at least one memory and operable to cause the UE to receive, from a NE via a first carrier, one or more synchronization signals and a first portion of minimum system information, transmit an uplink wake-up signal, where the uplink wake-up signal is associated with a PLMN of the NE, and receive a second portion of the minimum system information via a second carrier.

A processor for wireless communication is described. The processor may be configured to, capable of, or operable to perform one or more operations as described herein. For example, the processor may be configured to, capable of, or operable to cause a user equipment to receive, from a NE via a first carrier, one or more synchronization signals and a first portion of minimum system information, transmit an uplink wake-up signal, where the uplink wake-up signal is associated with a PLMN of the NE, and receive a second portion of the minimum system information via a second carrier.

A method performed or performable by a UE for wireless communication is described. The method may include receiving, from a NE via a first carrier, one or more synchronization signals and a first portion of minimum system information, transmitting an uplink wake-up signal, where the uplink wake-up signal is associated with a PLMN of the NE, and receiving a second portion of the minimum system information via a second carrier.

In some implementations of the UE, the processor, and the method described herein, the at least one processor may be further configured to cause the UE to receive a configuration for the uplink wake-up signal together with cell selection information and cell access related information. In some implementations of the UE, the processor, and the method described herein, the first and second carriers may be the same carrier configured for a network energy savings mode with reduced transmission frequency, the synchronization signals and the first portion of minimum system information may be received using the low power radio, and the at least one processor may be further configured to cause the UE to monitor, using the low power radio, for at least one paging message during one or more LP-POs, where the one or more LP-POs are associated with the uplink wake-up signal, in response to successful reception of the at least one paging message, transmit a request for the second portion of the minimum system information, where the request for the second portion of the minimum system information is included in one of the uplink wake-up signal or a RACH message, and activate the main radio based at least in part on transmitting the uplink wake-up signal, where the second portion of minimum system information is received using the main radio.

In some implementations of the UE, the processor, and the method described herein, the first carrier may be configured for periodic frequent common signal transmission and the second carrier may be configured for a network energy savings mode with reduced transmission frequency, the synchronization signals and first portion of minimum system information may be received using the main radio, and the uplink wake-up signal may be transmitted via the second carrier using the main radio of the UE to indicate reselection of the UE to the second carrier. In some implementations of the UE, the processor, and the method described herein, the at least one processor may be further configured to cause the UE to monitor the second carrier for at least one paging message during one or more LP-POs using the low power radio, where the one or more LP-POs are associated with the uplink wake-up signal, and in response to successful reception of the at least one paging message, transmit a RACH message via the first carrier using the low power radio.

In some implementations of the UE, the processor, and the method described herein, the first carrier may be configured for network energy savings mode with reduced transmission frequency and the second carrier may be configured for periodic frequent common signal transmission, the synchronization signals and the first portion of minimum system information may be received using the low power radio, and the at least one processor may be further configured to cause the UE to monitor the second carrier for at least one paging message during one or more LP-POs using the low power radio, where the one or more LP-POs are associated with the uplink wake-up signal, and in response to successful reception of the at least one paging message, transmit a RACH message via the second carrier using the main radio.

### BRIEF DESCRIPTION OF THE DRAWINGS

FIG. 1 illustrates an example of a wireless communications system in accordance with aspects of the present disclosure.

FIG. 2 illustrates an example synchronization signal block (SSB), in accordance with aspects of the present disclosure.

FIG. 3 illustrates an example slot structure, in accordance with aspects of the present disclosure.

FIG. 4 illustrates an example master information block (MIB), in accordance with aspects of the present disclosure.

FIG. 5 illustrates an example signaling diagram, in accordance with aspects of the present disclosure.

FIG. 6 illustrates an example of sequence generation, in accordance with aspects of the present disclosure.

FIGS. 7 and 8 illustrate example signaling diagrams, in accordance with aspects of the present disclosure.

FIG. 9 illustrates an example of an SS raster, in accordance with aspects of the present disclosure.

FIG. 10 illustrates an example of a UE in accordance with aspects of the present disclosure.

FIG. 11 illustrates an example of a processor in accordance with aspects of the present disclosure.

FIG. 12 illustrates an example of an NE in accordance with aspects of the present disclosure.

FIG. 13 illustrates a flowchart of a method performed by a UE in accordance with aspects of the present disclosure.

FIG. 14 illustrates a flowchart of a method performed by an NE in accordance with aspects of the present disclosure.

### DETAILED DESCRIPTION

A wireless communications system includes one or more devices (e.g., UEs and NEs) that exchange signaling. “Initial access” refers to a process by which a device, such as a UE, establishes and configures an initial connection with a network or cell, e.g., via an NE. For example, an NE broadcasts, to UEs in a cell served by the NE, system information that enables the UE(s) to perform cell selection and reselection procedures and, if appropriate, initiate a connection establishment procedure to connect to the NE. Transmission channels for initial access include PSSs, SSSs, and PBCHs. In some examples, the NE may broadcast an initial access transmission referred to as a synchronization signal block (SSB), where the SSB includes PSS, SSS, and PBCH. The PBCH carries a master information block (MIB) that indicates system parameters for the cell, such as cell bandwidth, subcarrier spacing (SCS), and configuration of a control resource set (CORESET) #0. The NE broadcasts the initial access transmission according to a transmission periodicity.

When a UE enters the cell, the UE monitors one or more transmission channels to receive the information broadcast by the NE. The UE, for instance, synchronizes with the NE by receiving the PSS and/or SSS, and decodes the PBCH to obtain the MIB indicating configuration parameters for the cell. The UE monitors the CORESET #0 to determine scheduling information (e.g., time-frequency resource(s)) for receiving a system information block (SIB) 1. The SIB1 includes additional network access information of categories such as cell selection information, cell access related information, connection establishment failure control, system information (SI) scheduling information, serving cell common configuration, internet protocol (IP) multimedia subsystem (IMS) emergency support flag, eCall over IMS support flag, UE timers and constants, UAC barring information, use full resume identity (ID) flag, and the like, among other examples. The SIB1 is transmitted by the NE according to a transmission periodicity.

In some examples, the UE may store the information indicated in the SIB1, camp on the cell and transition to a low power operating mode, such as an idle or inactive mode (e.g., radio resource control (RRC) idle mode, RRC inactive mode). While in the idle mode, the UE utilizes the SSB and the SIB1 to perform one or more idle mode procedures, such as cell selection or reselection, evaluating cell quality, and monitoring for paging messages from the NE. The UE may remain in the idle mode until the arrival of mobile originated (MO) traffic (e.g., to be transmitted to the NE) or successful reception of a paging message notifying the UE of an incoming transmission (e.g., to be received from the NE). Using the SSB and the SIB1, the UE can then initiate a connection establishment procedure and transition from the idle mode to a connected mode (e.g., RRC connected mode) to communicate with the NE.

A wireless device, such as an NE and/or a UE, may operate with different power consumption levels in different power consumption modes, such as a high power consumption mode (e.g., an active mode, a high-power mode, or a full-power mode) and a lower power consumption mode (e.g., an idle mode, an inactive mode, or a low-power mode). A wireless device operating in a lower power consumption mode may operate using reduced transmission and reception capabilities due to reduced transmit power, energy efficient radio transceivers, low power processors, or may utilize sleep modes for different components of the wireless device. In some examples, a wireless device may include multiple components, such as multiple radios or multiple receivers, including a low-power component that operates using a low power consumption level (e.g., a low-power radio (LPR), a low-power receiver, a low-power transmitter), and a high-power component that operates at a higher power consumption level (e.g., a main power radio, also referred to as a main radio (MR), a main transmitter, or a main receiver). The wireless device may transition the high-power component from an activated, operating, or executing state to a non-activated, non-operating, or non-executing state, also referred to as putting the high-power component to sleep or transferring to a sleep mode. The wireless device may transition the high-power component from a non-activated, non-operating, or non-executing state to an activated, operating, or executing state, also referred to as waking up the high-power component or transferring to a wake mode.

Network energy savings may be achieved during no-load and low-load conditions by reducing the transmission frequency of always-on common channels and signals. In conventional 5G NR systems, SSBs containing PSS, SSS, and PBCH are transmitted with a default periodicity of 20 ms, regardless of network traffic conditions. This continuous transmission approach ensures reliable UE access but results in unnecessary energy consumption during periods when no UEs require network access. Certain channels and signals remain necessary for UEs to perform cell detection and verification procedures, including initial synchronization, cell identity determination, and system information acquisition. UE power savings may be achieved to compensate for increased cell detection time that results from sparse transmission of common channels and signals, where UEs may utilize low power receiver chains to monitor reduced-frequency transmissions.

Because a UE, an NE, or both may be operating in a low power mode or may otherwise have an inactive MR, configuration and transmission of uplink (UL) wake-up signals (UL WUS) may be utilized for requesting on-demand minimum system information. However, without proper restrictions, any UE may transmit an UL WUS after merely detecting the presence of a cell, even if the UE is not associated with a PLMN of the cell. This may enable unauthorized wake-up transmissions that interfere with energy savings objectives. Moreover, existing on-demand system information approaches may not consider scenarios involving LPR configurations with limited processing capabilities.

The techniques described herein address LPR initial access with uplink wake-up signals that enable network energy savings while maintaining UE access capabilities. When a UE has no activity or expected traffic, a UE can receive minimal remaining minimum system information (RMSI) from a network and monitor for paging messages or MO traffic using LPR components. The minimal RMSI may be referred to or understood as a subset of RMSI (e.g., a reduced RMSI compared to existing/conventional RMSI). Upon reception of a paging message or detection of MO traffic, the UE can transmit a request to the network for the rest of the system information. The request may be, for example, included in an UL WUS or in a RACH message, such as a RACH Msg1. The uplink wake-up signal transmission may be restricted to UEs that have successfully detected the cell and whose PLMN identity is associated with that cell. For example, the UE may receive (e.g., as part of the RMSI) an UL WUS configuration that is associated with the PLMN. In implementations, the UL WUS configuration is associated with cell selection and cell access related parameters, enabling the UE to determine cell selection suitability based on signal quality measurements and access control parameters before transmitting UL WUS to request on-demand transmission of additional minimum system information such as remaining PBCH content or SIB1.

The described techniques further provide for a two-stage synchronization signal transmission configuration, in which synchronization signals are separated into distinct transmission phases. An NE may, for example, transmit a first stage synchronization signal on a sparse frequency raster using a LPR. The first stage SS may include only a PSS. Alternatively, the first stage SS may be a unique SS dedicated for indication of the presence of a second stage SS transmission. The sparse frequency raster utilizes wider frequency spacing between candidate positions compared to conventional synchronization rasters, reducing the number of frequency positions that UEs need to monitor during cell search procedures. When the first stage SS includes the PSS, the second stage SS may include an SSS and PBCH. Alternatively, when the first stage SS indicates the presence of the second stage SS, the second stage SS may include the PSS, the SSS, and the PBCH. The second stage SS may utilize the same or a different frequency raster as the first stage SS. In either case, upon detecting the first stage SS, a UE can transmit the UL WUS to request on-demand transmission of the second stage synchronization signal. In this manner, the signaling overhead of on-demand SI can be further reduced. In some examples, the NE may implement PLMN-scrambled synchronization signals where the PSS and SSS are scrambled with PLMN identification information using scrambling sequences derived from the PLMIN identification.

The described techniques provide improvements over conventional initial access mechanisms by addressing fundamental inefficiencies in current 5G NR implementations where synchronization signals and system information are transmitted continuously regardless of network traffic conditions. By implementing LPR configurations with restricted uplink wake-up signal transmission, the techniques described herein improve network energy efficiency by reducing unnecessary transmission of common channels during no-load and low-load periods while maintaining UE access capabilities through on-demand system information delivery. The PLMN-based restriction mechanism prevents unauthorized wake-up signal transmissions from random UEs, ensuring that only UEs that have successfully completed cell selection and PLMN verification procedures may request on-demand system information, thereby preserving energy savings and preventing interference from non-associated devices. Additionally, by transmitting SSs according to the two-stage SS configuration and/or according to a sparse frequency raster, the described techniques reduce UE power consumption by minimizing the number of frequency positions that must be monitored during cell search procedures. These techniques enable both network-side and UE-side energy savings without compromising access reliability, supporting enhanced battery life for IoT devices and reduced operational costs for network operators through improved power management strategies across different network loading conditions.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

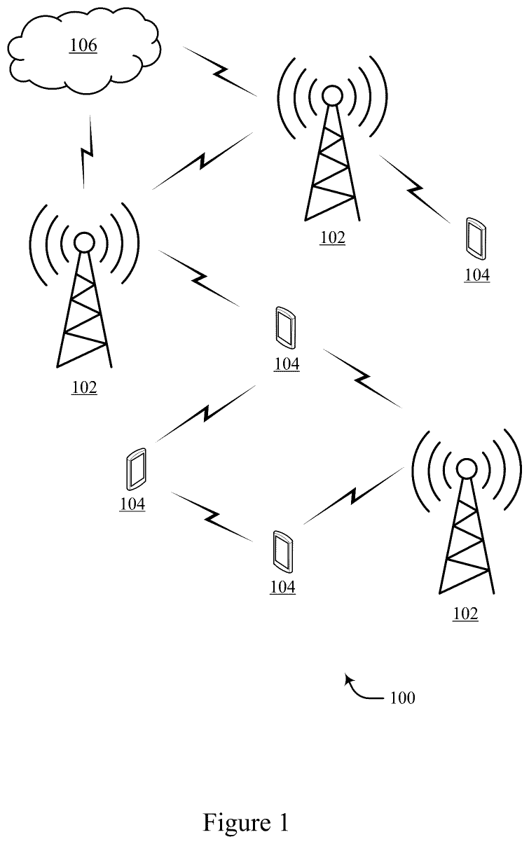

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., y=0) may be associated with a first subcarrier spacing (e.g., 15 kHz) and a normal cyclic prefix. In some implementations, the first numerology (e.g., y=0) associated with the first subcarrier spacing (e.g., 15 kHz) may utilize one slot per subframe. A second numerology (e.g., y=l) may be associated with a second subcarrier spacing (e.g., 30 kHz) and a normal cyclic prefix. A third numerology (e.g., y=²) may be associated with a third subcarrier spacing (e.g., 60 kHz) and a normal cyclic prefix or an extended cyclic prefix. A fourth numerology (e.g., y=³) may be associated with a fourth subcarrier spacing (e.g., 120 kHz) and a normal cyclic prefix. A fifth numerology (e.g., y=⁴) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., y=0), which includes 15 kHz subcarrier spacing; a second numerology (e.g., y=1), which includes 30 kHz subcarrier spacing; and a third numerology (e.g., y=²), which includes 60 kHz subcarrier spacing. FR2 may be associated with one or multiple numerologies (e.g., at least 2 numerologies). For example, FR2 may be associated with a third numerology (e.g., y=²), which includes 60 kHz subcarrier spacing; and a fourth numerology (e.g., y=³), which includes 120 kHz subcarrier spacing.

An NE 102 in the wireless communications system 100 serves one or more cells, such as primary serving cells (PCells) and secondary serving cells (SCells). To provide system and cell information to UEs 104 entering a cell served by the NE 102, the NE 102 periodically broadcasts system information messages indicating configurations and parameters for the cell. System information messages include synchronization signals (PSS, SSS), synchronization signal blocks (SSBs), PBCH including MIB, and SIBs (SIB0, SIB1). Each system information message type is associated with a respective transmission periodicity and modification periodicity to facilitate initial cell search, radio resource management (RRM) measurements, and mobility procedures. For example, SIB1 and SSB may each have a 20 millisecond (ms) periodicity, MIB may have a modification periodicity of 80 ms, while SIB1 may have a modification periodicity of 160 ms.

SSBs include reference signals for channel estimation and beam management and may include PSS, SSS, and PBCH. The PSS and SSS enable UEs 104 in or entering the cell to achieve time and frequency synchronization with a network and to identify the cell. The PBCH carries system information, including MIB, which includes parameters such as a system frame number (SFN), subcarrier spacing (SCS), and initial downlink bandwidth part (BWP) configuration. The MIB indicates scheduling information for communication of SIB1, including configuration information for CORESET0, which includes a Type0-PDCCH common search space. CORESET0 occupies a quantity of resource elements (REs), including a quantity of resource blocks (RBs) in the frequency domain and a quantity of OFDM symbols in the time domain, based on a bandwidth and numerology of the cell.

When a UE 104 enters the cell, the UE 104 monitors one or more transmission channels to receive the system information broadcast by the NE 102. The UE 104 utilizes the system information to perform initial cell selection procedures and cell access procedures. The UE 104 evaluates the cell to determine cell quality, barring information, available service types, and cell access information to determine whether the cell is a candidate for selection. If the cell has poor quality or is configured with service restrictions, the UE 104 may refrain from selecting the cell and may instead perform cell reselection to evaluate neighboring cells. Alternatively, the UE 104 utilizes system information to camp on the cell and may transition to a low power operating mode, such as an idle or inactive mode, while monitoring for paging messages from the NE 102.

The NE 102 may transmit paging messages to one or more UEs 104 during one or more paging occasions (POs) configured within a paging cycle, where a paging cycle configures the interval between consecutive POs. A PO may be defined as a set of PDCCH monitoring occasions and may include multiple time slots during which an NE 102 may transmit a paging downlink control information (DCI) message. A paging frame is a radio frame in which one or more POs are being transmitted and is typically set to a value that aligns with the radio frame boundary of a cell. A PO is typically a particular subframe within a paging frame in which a paging radio network temporary identifier (P-RNTI) is transmitted on the PDCCH addressing a paging message. A paging message includes information to notify a UE 104 of an incoming transmission and may include a UE identity, a cause for paging, and other relevant information. The NE 102 may transmit a paging message in a physical downlink shared channel (PDSCH) scheduled by control signaling received via PDCCH.

A UE 104 may include a LPR and a main power radio. The LPR operates at a lower power level, consuming less energy than the MR, and may operate at a lower frequency, have fewer antennas, be a receive-only radio, or communicate at a lower data rate than the MR. The UE 104 may transition the MR to a low power state due to there being no data to communicate to or from the NE 102. While the MR is in the low power state, the NE 102 may communicate at least one paging message during one or more LR-POs (e.g., POs configured for use in a low power operating mode or by low power devices). The LPR of the UE 104 monitors the one or more LR-POs for the at least one paging message and, in response to reception of the at least one paging message, causes the MR to transition to a high power state.

The UE 104 may operate in idle mode while monitoring for paging messages from the NE 102. When the UE 104 detects a paging message addressed to the UE 104, the UE 104 initiates a connection establishment procedure with the NE 102 to receive the incoming data transmission. The UE 104 utilizes information from the SSB and the SIB1 to request RRC setup with the NE 102 and transition to a connected mode by transmitting a RACH preamble (PRACH) to the NE 102 via one or more RACH resources indicated by the SIB1.

A SIB0 may be understood as a reduced system information message that carries a subset of the information conventionally carried in SIB1 and has a reduced payload size compared to SIB1. SIB0 includes the minimum information required for an idle mode UE 104 to operate in a cell served by an NE 102, which may be referred to as RMSI. The SIB0 excludes information not used by the idle mode UE 104, such as RACH procedure information and BWP configuration information, which is carried by SIB1. The NE 102 transmits SIB0 more frequently than SIB1 to reduce network energy consumption and signaling overhead associated with SIB1 transmission while providing UEs 104 with access information via SIB0 without delay. When the UE 104 is ready to transition to a connected mode, the UE 104 receives SIB1 indicating additional access information and utilizes this information to initiate a connection establishment procedure with the NE 102.

According to the techniques described herein, the wireless communications system 100 implements network energy savings (NES) features through LPR configurations at both the NE 102 and UE 104 sides. For example, an NE 102 serving a cell may operate in an NES or low power mode, e.g., using a LPR while a MR is asleep or otherwise inactive. While in the low power/NES mode, the NE 102 transmits one or more SSs and a first portion of minimum system information via a first carrier using a low-power radio, where the first portion of minimum system information comprises a subset of RMSI (e.g., a reduced subset of RMSI, also referred to as reduced RMSI) that includes essential parameters for cell detection and access control. The subset of RMSI may be further reduced than the SIB0 and may include an UL WUS configuration. In some examples, the subset of RMSI is split into one or more segments, and each segment is conveyed through sequence selection using orthogonal sequences such as Zadoff-Chu sequences, with each segment having a respective transmission periodicity to optimize power consumption and access latency.

Additionally, the NE 102 may transmit one or more paging messages in one or more LP-POs. In response to receiving a paging message, MO traffic, and/or the one or more SSs and the first portion of minimum SI, a UE 104 in the cell may transmit an UL WUS associated with a PLMN of the cell (e.g., of the NE 102). The UL WUS may indicate a request for the remaining system information. By associating the UL WUS with the PLMN, the UL WUS transmission is restricted to UEs 104 that have performed cell selection based on cell selection information and cell access related information associated with the cell, thereby preventing UEs 104 from transmitting UL WUS after merely detecting cell presence through synchronization signal reception. This restriction mechanism operates by requiring UEs 104 to first decode the reduced subset of RMSI containing PLMN identity information and/or the UL WUS configuration before being authorized to transmit UL WUS.

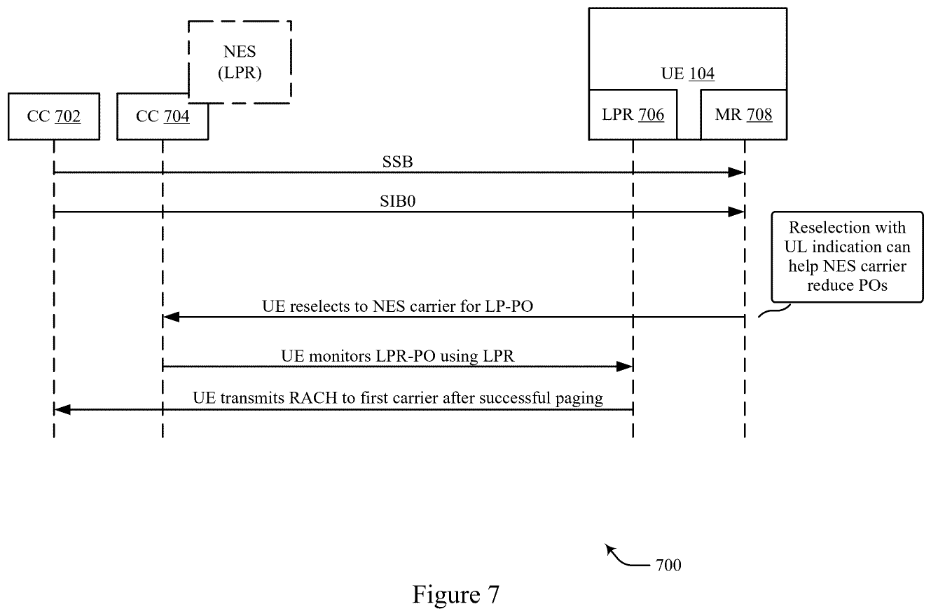

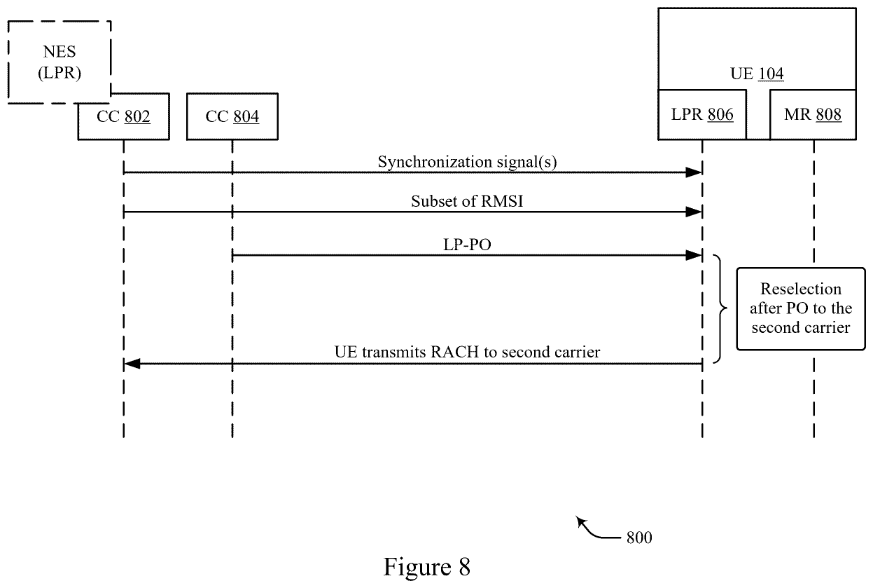

Upon receiving a UL WUS from an authorized UE 104, the NE 102 activates its MR and transmits a second portion of minimum system information including the rest of the parameters needed for the UE 104 to connect to and access the cell. In some examples, the one or more SSs, the first portion of minimum system information, the paging message(s), the second portion of minimum system information, and the UL WUS may be communicated via a carrier configured (e.g., by the NE 102) for NES communications. Additionally, or alternatively, the NE 102 may support multiple carrier configurations to accommodate different energy savings scenarios and UL WUS procedures. For example, as described with reference to FIG. 7, the NE 102 may configure a first carrier for periodic frequent common signal transmission and a second carrier for NES (e.g., for a low power/NES mode with reduced transmission frequency). The second carrier may have a relatively narrow bandwidth, such as 5 MHz. The UE 104 may receive the SSs and the first portion of minimum system information via the first carrier, then reselect to the second carrier and transmit UL WUS via the second carrier to indicate the reselection and/or to request additional system information. Alternatively, as described with reference to FIG. 8, the UE 104 may receive the SSs and the first portion of minimum system information via the second carrier (e.g., via the NES carrier) using its LPR, then monitor the second carrier (e.g., the periodic frequent common signal transmission carrier) for paging messages and transmit RACH messages via either carrier using its MR when network access is required.

Additionally, or alternatively, the NE 102 may utilize a two-stage SSB configuration where synchronization signals are separated into distinct transmission phases to enable independent power management. The NE 102 may transmit a first stage SS on a sparse frequency raster using the low-power radio, which may include only PSS or a dedicated SS that indicates presence of a second stage transmission. The sparse frequency raster utilizes wider frequency spacing between candidate positions compared to conventional synchronization rasters, reducing the number of frequency positions that UEs 104 need to monitor during cell search procedures and thereby decreasing UE power consumption. Upon detecting the first stage signal, the UE 104 transmits a UL WUS to request on-demand transmission of the second stage SS, which includes at least SSS and PBCH. If the first stage SS does not include the PSS, the second stage SS includes the PSS.

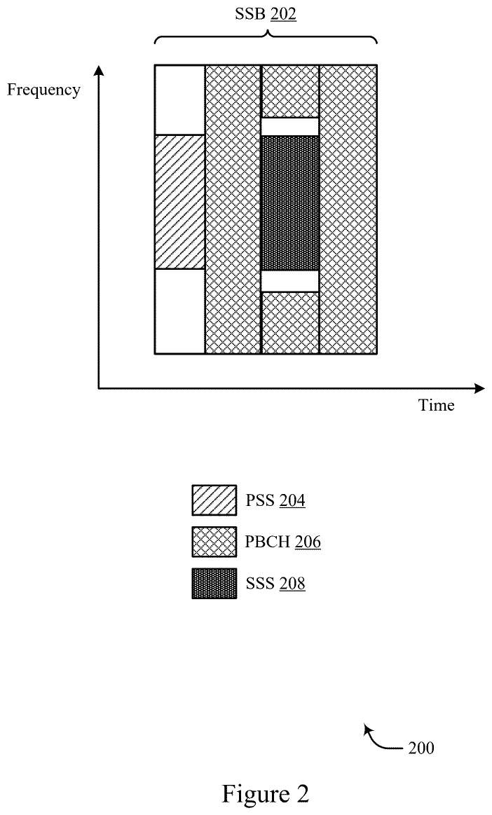

FIG. 2 illustrates an example SSB 200 in accordance with aspects of the present disclosure. In some examples, the SSB 200 implements or is implemented by aspects of the wireless communications system 100. The SSB 200 may be implemented by a UE or an NE, which may be examples of a UE 104 and an NE 102 as described with reference to FIG. 1. For example, an NE may broadcast an SSB 200 to UEs in a cell served by the NE.

In 5G NR systems, an SSB burst structure spans a 5 ms duration, corresponding to half of a radio frame. SSB transmission may occur in either the first half or second half of a 10 ms radio frame, with this timing information indicated in a corresponding MIB. For UEs performing initial network access procedures, the default SSB periodicity is configured at 20 ms intervals, while the actual operational periodicity of SSBs is subsequently indicated within SIB1 after successful initial access.

The maximum number of candidate SSB transmissions within a wireless communications system is determined by an operating frequency range and configured subcarrier spacing parameters. For frequency range 1 (FR1), which encompasses frequencies below 6 GHz, the maximum number of candidate SSBs is limited to 8. In contrast, FR2, covering frequencies above 24 GHz, supports up to 64 candidate SSB transmissions to accommodate the higher frequency propagation characteristics and beam management requirements.

PSS 204 204, SSS 208 208, and PBCH 206 206 are transmitted as a unified structure within consecutive Orthogonal Frequency Division Multiplexing (OFDM) symbols, forming a complete SSB (e.g., the SSB 200). The PSS 204 provides coarse timing and frequency synchronization, the SSS 208 enables cell identity determination and fine synchronization, and the PBCH 206 carries the MIB containing system parameters such as system frame number, subcarrier spacing configuration, and CORESET #0 scheduling information. Each SSB occupies a time-frequency resource allocation of 4 consecutive OFDM symbols in the time domain and spans 240 subcarriers, equivalent to 20 resource blocks (RBs), in the frequency domain. The 4-symbol structure provides a compact transmission format that may be repeated within SSB burst sets according to configured periodicities, where each RB comprises 12 subcarriers with 15 kHz subcarrier spacing in FR1 implementations.

Time-frequency resource allocations may be positioned at different locations within a slot depending on the SSB case configuration and operating frequency band. In the example of FIG. 2, the PSS 204 is positioned within the first OFDM symbol of the SSB structure and occupies 127 subcarriers. The PSS 204 utilizes Zadoff-Chu sequences with length 127, where three different root indices (29, 34, and 25) correspond to PCI values modulo 3, enabling UEs to determine partial cell identity information during initial synchronization. The PSS 204 sequence is mapped to subcarriers 56 through 182 within the 240-subcarrier SSB bandwidth, with guard subcarriers on both sides to minimize interference with adjacent frequency allocations.

The SSS 208 is located within the third OFDM symbol and similarly spans 127 subcarriers. The SSS 208 frequency allocation includes 8 unused subcarriers positioned below the SSS 208 and 9 unused subcarriers positioned above the SSS 208 within the same OFDM symbol. The SSS 208 employs Gold sequences of length 127 that are generated using two m-sequences with different initialization parameters derived from the physical cell identity (PCI), enabling UEs to determine the complete PCI value when combined with PSS 204 information. The SSS 208 sequence provides 336 unique cell identity groups, and the asymmetric guard band allocation (8 subcarriers below, 9 subcarriers above) may accommodate implementation-specific filtering requirements and reduce inter-symbol interference.

The PBCH 206 utilizes a distributed resource allocation pattern, occupying two complete OFDM symbols (e.g., the second and fourth symbols) with full 240-subcarrier coverage, and additionally occupying 48 subcarriers positioned below and above the SSS 208 within the third OFDM symbol. This distributed allocation results in the PBCH 206 occupying a total of 576 subcarriers across three OFDM symbols (240+48+48+240=576). The distributed PBCH 206 allocation enables frequency diversity across the SSB bandwidth and may improve reception reliability in frequency-selective fading channels. The PBCH 206 carries a 24-bit MIB payload that undergoes channel coding, rate matching, and scrambling operations before modulation using quadrature phase shift keying (QPSK). Demodulation reference signals (DMRS) are embedded within the PBCH 206 resource elements to enable channel estimation and coherent demodulation at the UE receiver.

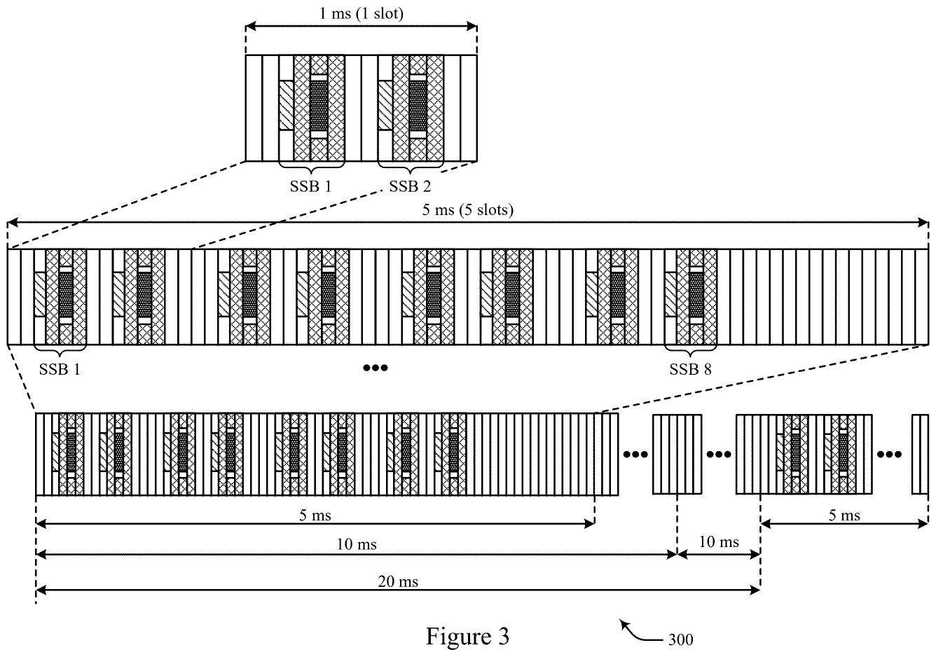

FIG. 3 illustrates an example slot structure 300 in accordance with aspects of the present disclosure. In some examples, the slot structure 300 implements or is implemented by aspects of the wireless communications system 100. The slot structure 300 may be implemented by a UE or an NE, which may be examples of a UE 104 and an NE 102 as described with reference to FIG. 1. For example, an NE may broadcast SSBs to UEs in a cell served by the NE according to the slot structure 300.

As shown, multiple SSBs (e.g., SSB 1 through SSB 8) may be transmitted within a defined SSB burst period. Each SSB may occupy one slot (e.g., approximately 1 ms), and a set of SSBs may be transmitted sequentially within a shorter burst interval (e.g., approximately 5 ms), which may repeat periodically over a longer time duration such as 10 ms or 20 ms. The illustrated SSBs may be transmitted in different spatial directions or beams and/or according to different frequency resources, enabling a UE to detect a suitable SSB and thereby acquire initial timing, frequency, and cell identification information.

In conventional NR implementations, the PSS, SSS, and PBCH forming the complete SSB are transmitted as a unified structure with synchronized timing. Additionally, CORESET #0, which contains the scheduling information required for SIB1 reception, is transmitted with the same 20 ms periodicity that corresponds to the default SIB1 transmission interval. This ensures that UEs can reliably acquire both the synchronization signals and the scheduling information needed for subsequent system-information reception.

The present disclosure addresses methods for configuring on-demand system-information transmission using LPR capabilities at the NE transmitter side, while correspondingly utilizing low-power receiver functionality on the UE side. In certain embodiments, the NE may reduce the transmission frequency of one or more always-on or duty cycle-based common channels and/or associated signals during periods of low or no traffic load, while maintaining the ability to provide system information when requested by UEs. Such techniques may enable network-side energy savings while supporting continued UE access and system-information retrieval on demand.

Although representative timing relationships, periodicities, and SSB counts are shown, other configurations may be utilized in various implementations. For example, Table 1 illustrates SSB designs for different frequency ranges and subcarrier spacings.

TABLE 1

| | OFDM starting | f_c ≤ 3 | 3 GHz < f_c ≤ | |
|---|---|---|---|---|
| | symbols of the | GHz | 6 GHz | f_c > 6 GHz |
| SCS | candidate SSBs | L_max = 4 | L_max = 8 | L_max = 4 |
| Case | {2, 8} + 14n | n = 0, 1 | n = 0, 1, 2, 3 | NA |
| A: 15 | | {2, 8, 16, | {2, 8, 16, | |
| kHz | | 22} | 22, 30, 36, 44, | |
| | | | 50} | |
| Case | {4, 8, 16, | n = 0 | n = 0, 1 | NA |
| B: 30 | 20} + 28n | {4, 8, 16, | {4, 8, 16, 20, | |
| kHz | | 20} | 32, 36, 40, | |
| | | | 48} | |
| Case | {2, 8} + 14n | n = 0, 1 | n = 0, 1, 2, 3 | NA |
| C: 30 | | {2, 8, 16, | {2, 8, 16, 22, | |
| kHz | | 22} | 30, 36, 44, | |
| | | | 50} | |
| Case | {4, 8, 16, | NA | NA | n = |
| D: | 20} + 28n | | | 0, 1, 2, 3, 5, 6, 7, 8, |
| 120 | | | | 10, 11, 12, 13, 15, |
| kHz | | | | 16, 17, 18 |
| | | | | {4, 8, 16, 20 . . . |
| | | | | 508, 512, 520, 524} |
| Case | {8, 12, 16, | NA | n = 0, 1, 2, 3, | NA |
| E: | 20, 32, 36, | | 5, 6, 7, 8 | |
| 240 | 40, 44} + 56n | | {8, 12, 16, 20 | |
| kHz | | | 480, 484, | |
| | | | 488, 492} | |

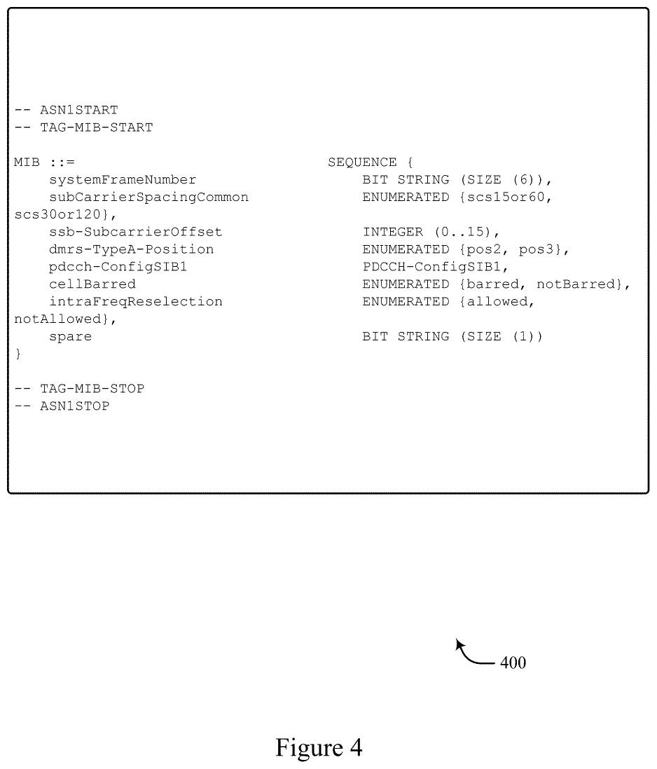

FIG. 4 illustrates an example MIB 400 in accordance with aspects of the present disclosure. In some examples, the MIB 400 implements or is implemented by aspects of the wireless communications system 100. The MIB 400 may be implemented by a UE or an NE, which may be examples of a UE 104 and an NE 102 as described with reference to FIG. 1. For example, an NE may broadcast an SSB (e.g., via PBCH) that includes the MIB 400 to UEs in a cell served by the NE.

The MIB 400 provides fundamental system information necessary for initial access, such as timing and control channel configuration, to a UE. The minimum requirement for a UE to camp on a cell is successful decoding of both MIB and SIB1. The MIB is carried by the PBCH, which forms part of the SSB structure, while SIB1 is carried by the PDSCH. The MIB carries essential information including reference subcarrier spacing, control channel configuration for SIB PDSCH transmission, and DMRS position parameters. Additionally, the MIB 400 indicates CORESET #0 configuration information defining the location and configuration of control channels (e.g., PDCCH). For example, the MIB 400 indicates scheduling information (e.g., time-frequency resources) for Type0-PDCCH search space within CORESET #0 where the UE can receive additional (e.g., more detailed) system information, such as SIB1. SIB1 carries comprehensive basic information required for the UE to perform initial attachment procedures through RRC setup completion. Additionally, SIB1 carries scheduling information for other system information blocks, enabling the UE to acquire additional configuration parameters as needed for network operation.

Tables 2 and 3 describe PDCCH search spaces and associated parameters.

TABLE 2

| | Search | | |
|---|---|---|---|
| Type | Space | RNTI | Use Case |
| Type0- | Common | SI-RNTI for RMSI | SIB Decoding |
| PDCCH | | on a primary cell | (SIB1) |
| Type0A- | Common | SI-RNTI on a | SIB Decoding |
| PDCCH | | primary cell | (Other SIBs) |
| Type1- | Common | RA-RNTI, TC-RNTI, | Msg2, Msg4 |
| PDCCH | | C-RNTI on a primary | decoding |
| | | cell | in RACH |
| Type2- | Common | P-RNTI on a primary cell | Paging |
| PDCCH | | | Decoding |
| Type3- | Common | INT-RNTI, SFI-RNTI, | System |
| PDCCH | | TPC-PUSCH-RNTI, | information or |
| | | TPC-PUCCH-RNTI, | other common |
| | | TPC-SRS-RNTI, C- | control |
| | | RNTI, CS-RNTI(s), | |
| | | SP-CSI-RNTI | |
| UE-SS | UE | C-RNTI, or CS-RNTI(s), | User-specific |
| | Specific | or SP-CSI-RNTI | PDSCH |
| | | | decoding |

TABLE 3

| Type | Signaling Parameters |
|---|---|
| Type0-PDCCH | Type0-PDCCH > pdsch-ConfigSIB1 in |
| | MasterInformationBlock |
| Type0A- | Type0-PDCCH > searchSpaceSIB1 in |
| PDCCH | PDCCH-ConfigCommon |
| Type1-PDCCH | Type0-PDCCH > searchSpaceZero in |
| | PDCCH-ConfigCommon |
| Type2-PDCCH | Type0-PDCCH > |
| | searchSpaceOtherSystemInformation |
| | in PDCCH-ConfigCommon |
| Type3-PDCCH | Type0-PDCCH > ra-SearchSpace in |
| | PDCCH-ConfigCommon |
| Type2-PDCCH | Type0-PDCCH > pagingSearchSpace |
| | in PDCCH-ConfigCommon |
| Type0-PDCCH | Type0-PDCCH > SearchSpace in PDCCH-Config |
| | with search SpaceType = common |
| UE Specific | Type0-PDCCH > SearchSpace in PDCCH-Config |
| | with searchSpaceType = ue-specific |

Table 4 provides descriptions of fields included in the MIB 400.

TABLE 4

MIB field descriptions
cellBarred
Value barred means that the cell is barred, as
defined in TS 38.304 [20].
dmrs-TypeA-Position
Position of (first) DM-RS for downlink
(see TS 38.211 [16], clause 7.4.1.1.2) and
uplink (see TS 38.211 [16], clause 6.4.1.1.3).
intraFreqReselection
Controls cell selection/reselection to
intra-frequency cells when the highest
ranked cell is barred, or treated as barred
by the UE, as specified in TS 38.304 [20]
pdcch-ConfigSIB1
Determines a common ControlResourceSet
(CORESET), a common search
space and necessary PDCCH parameters.
If the field ssb-SubcarrierOffset
indicates that SIB1 is absent, the field
pdcch-ConfigSIB1 indicates the
frequency positions where the UE may
find SS/PBCH block with SIB1 or the
frequency range where the network
does not provide SS/PBCH block with SIB1
(see TS 38.213 [13], clause 13).
ssb-SubcarrierOffset
Corresponds to k_{SSB} (see TS 38.213 [13]),
which is the frequency domain offset
between SSB and the overall resource block
grid in number of subcarriers. (See
TS 38.211 [16], clause 7.4.3.1).
The value range of this field may be
extended by an additional most significant
bit encoded within PBCH as
specified in TS 38.213 [13].
This field may indicate that this cell
does not provide SIB1 and that there is
hence no CORESET#0 configured in
MIB (see TS 38.213 [13], clause 13). In
this case, the field pdcch-ConfigSIB1
may indicate the frequency positions
where the UE may (not) find a SS/PBCH
with a control resource set and search
space for SIB1 (see TS 38.213 [13], clause 13).
subCarrierSpacingCommon
Subcarrier spacing for SIB1, Msg.2/4 for
initial access, paging and broadcast
SI-messages. If the UE acquires this MIB
on an FR1 carrier frequency, the
value scs15or60 corresponds to 15 kHz
and the value scs30or 120 corresponds
to 30 kHz. If the UE acquires this MIB
on an FR2 carrier frequency, the value
scs15or60 corresponds to 60 kHz and the
value scs30or 120 corresponds to 120
kHz.
systemFrameNumber
The 6 most significant bits (MSB) of the
10-bit System Frame Number (SFN).
The 4 LSB of the SFN are conveyed in
the PBCH transport block as part of
channel coding (i.e. outside the MIB
encoding), as defined in clause 7.1 in TS
38.212 [17]

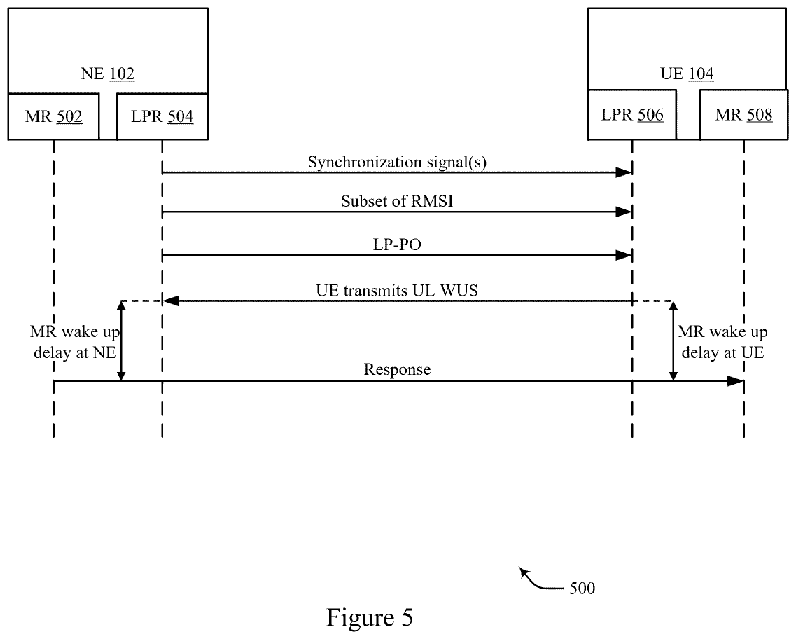

FIG. 5 illustrates an example signaling diagram 500 in accordance with aspects of the present disclosure. In some examples, the signaling diagram 500 may implement aspects of the wireless communications system 100. For example, the signaling diagram 500 illustrates communication between a UE 104 and an NE 102, which may include or be examples of the corresponding devices as described with reference to FIG. 1. Alternative examples of the following may be implemented, where some processes are performed in a different order than described or are not performed. In some cases, processes may include additional features not mentioned below, or further processes may be added.

The signaling diagram 500 illustrates a communication scenario implementing an LPR configuration at the NE 102 and a corresponding LPR configuration at the UE 104 for portions of the initial access procedure, such as on-demand acquisition of system information. In this scenario, the NE 102 operates with both a MR 502 and a LPR 504, while the UE 104 similarly includes a LPR 506 and a MR 508. The LPRs 504 and 506 operate at reduced power and computational levels compared to the MRs 502 and 508.

The NE 102 utilizes the LPR 504 to transmit (e.g., broadcast) synchronization signals in a cell served by the NE 102, generating the synchronization signals using reduced computational resources and minimal power amplification. The UE 104, operating in the cell, receives the synchronization signals using the LPR 506. The NE 102 utilizes a synchronization raster configuration to transmit synchronization signals including PSSs and SSSs, or partial synchronization signals such as PSSs alone, or dedicated synchronization signals that indicate presence of subsequent synchronization signal transmissions.

The NE 102 transmits a first portion of minimum system information to the UE 104 via the LPR 504. The first portion of minimum system information comprises a reduced subset of RMSI that includes essential parameters for cell detection and access control, where the reduced subset contains less information than conventional SIB0 transmissions. The subset of RMSI may additionally include a configuration for UL WUS, which may indicate a mapping or other association between the UL WUS and a PLMN of the cell. The payload of the subset of RMSI may be divided into multiple parts for transmission using sequences, where each part may be transmitted with different periodicity to optimize power consumption and latency. For example, time-sensitive information such as system frame number may be transmitted more frequently than static configuration parameters such as cell access control information. The multiple parts may include or be an example of an MSI part 1 and/or an MSI part 2 as described herein, although other examples, configurations, and combinations may be implemented.

The NE 102 may implement the LPR 504 using sequence-based transmission as described herein. The low power transmitter implementation may optionally incorporate hardware simplifications including a reduced number of antenna elements for decreased spatial complexity, a reduced number of transmission ports for simplified signal processing, reduced operational bandwidth for lower computational requirements, or combinations thereof to achieve additional power savings.

In some examples, transmission of the reduced subset of RMSI and/or the SSs may be via a single carrier configured for NES and/or low power operating modes associated with reduced transmission frequency (e.g., reduced periodicity, reduced occurrence of transmissions), referred to herein as an NES carrier. The carrier may have a limited and relatively narrow bandwidth, such as 5 MHz. The periodic transmission intervals may be extended compared to conventional implementations.

The UE 104 monitors for paging messages during LP-POs (e.g., designated monitoring periods configured for energy-efficient operation). The NE 102 may transmit one or more paging messages during one or more LP-POs, e.g., using LPR capabilities with extended paging cycles and sparse paging occasion monitoring to reduce both network transmission overhead and UE monitoring power consumption. Upon reception of a low power paging message, the UE 104 may utilize the LPR 506 to perform sequence matching operations for signal detection and information decoding. The LPR 506 may incorporate hardware simplifications including a reduced number of reception antennas for decreased spatial processing complexity, a reduced operational bandwidth for lower sampling rates and simplified analog front-end processing, or combinations thereof to achieve UE power consumption reductions while maintaining adequate reception performance for the sequence-based transmission format.

Following reception of a paging message or detection of mobile originated traffic at the UE 104, the UE 104 transmits an uplink signal to activate the MR 502 of the NE 102, where the uplink signal comprises either an uplink wake-up signal or a random access channel message. For example, upon successfully receiving a paging indication, transmits an uplink wake-up signal or a RACH message to request additional system information (e.g., the remaining SI not included in the subset of RMSI). Upon receiving the uplink WUS and/or the RACH message, the NE 102 transitions from LPR operation to MR operation, activating the MR 502. Correspondingly, the UE 104 transitions from the LPR 506 to the MR 508, enabling full communication capabilities for subsequent data transmission procedures. The UE 104 then communicates (e.g., signals, transmits, receives) with the NE 102 using the MR 508.

A delay between the transmission/reception of the UL WUS may occur while the respective MRs wake up. In implementations, the maximum wake-up delay between the NE 102 MR activation and the UE 104 MR activation may be considered in system design to ensure proper timing alignment for subsequent communication procedures.

The MR 502 and MR 508 may be activated based on network activity triggers. For example, the NE 102 activates the MR 502 upon reception of wake-up signals or random access channel messages from the UE 104. The UE 104 transmits uplink wake-up signals to request on-demand system information only after completing PLMN selection procedures, ensuring that wake-up signal transmission is restricted to UE that has verified network association. The UE 104 activates the MR 508 upon reception of paging messages indicating network-initiated communication or upon detection of mobile originated traffic requiring uplink transmission capabilities.

In some examples, the SS(s) transmitted by the NE 102 may be a first stage synchronization signal (e.g., a PSS or a dedicated first stage SS different than the PSS) as described herein. In some examples, the SS(s) may remain unchanged from conventional implementations, maintaining the same Zadoff-Chu sequence structure and frequency domain mapping to ensure compatibility with existing UE synchronization algorithms.

The LPR 504 and 506 limitations may rely on the use of sequence-based transmission methods for MSI part 1 and MSI part 2, which may contain different content than conventional PBCH and SIB0 transmissions. The synchronization signals and partial minimum system information are transmitted using reduced computational resources and simplified signal processing compared to MR implementations.

In some examples, the NE utilizes a single NES carrier with LPR transmission for both MSI part 1 and MSI part 2. The MSI part 1 containing time-sensitive information such as cell barred indication and system frame number may be transmitted more frequently than MSI part 2 containing cell selection and access related information. The LPR constraints may limit the use of different orthogonal sequences for each MSI part to enable simple correlation-based detection at the UE receiver.

The multiple parts of the subset of RMSI may be transmitted with different sequences and/or periodicities to optimize power consumption and latency. For example, the MSI part 1 may include (but is not limited to):

Cell barred indication providing immediate access control information to prevent UEs from attempting access to restricted cells

SSB subcarrier offset parameter indicating the frequency domain offset between the SSB and the overall resource block grid for proper frequency alignment

System frame number information providing timing reference for UE synchronization and scheduling operations

Scheduling information for MSI part 2 using an index to a lookup table that maps to specific time and frequency resources for on-demand transmission.

The MSI part 2 may include (but is not limited to):

Cell selection information providing thresholds for determining cell quality measurements, including reference signal received power (RSRP) and reference signal received quality (RSRQ) criteria for cell ranking procedures

Cell access related information including PLMN information associated with the cell, where the number of supported PLMNs affects payload size. When RAN sharing is not supported, the number of PLMNs is typically one, reducing the required information field size

Unified Access Control (UAC) barring information with a limited number of access classes, providing access control mechanisms for different types of UEs and services during network congestion conditions

Paging related configuration including paging scheduling information such as paging cycle duration, paging monitoring slots within each paging frame, and values for paging frame formula calculations that determine when specific UEs should monitor for paging messages

UL WUS related configuration using an index to a row indicating sequence length for correlation detection, slot number for transmission timing, frame number for scheduling reference, guard period for interference avoidance, and other parameters needed for proper wake-up signal transmission and detection.

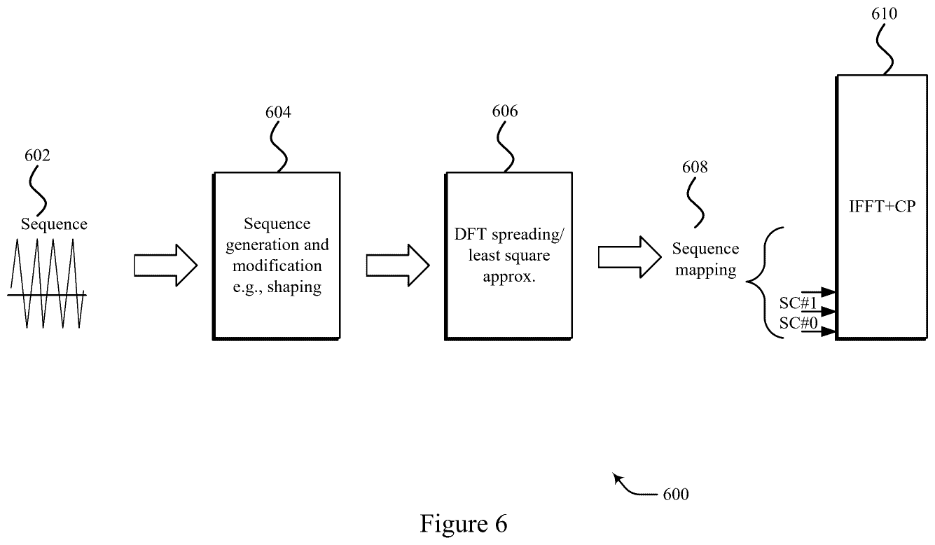

FIG. 6 illustrates an example 600 of sequence generation in accordance with aspects of the present disclosure. As illustrated in the example 600, a sequence 602 is input to a sequence generator and modifier 604, e.g., which shapes the sequence 602. The result is input to a Discrete Fourier Transform (DFT) spreader/least square approximator 606, which outputs a signal 608 that is provided to an IFFT 610 to generate an OFDM symbol that is enhanced with a cyclic prefix (CP). The signal may include or be an example of an UL WUS, a subset of RMSI (e.g., an MSI part 1, an MSI part 2, or the like), one or more SSs, or any combination thereof, among other examples.

Orthogonal sequences such as Zadoff-Chu sequences may be utilized, where DFT spread orthogonal frequency division multiplexing (DFT-s-OFDM) may be used at the transmitter to provide N sequences within one OFDM symbol. The DFT-s-OFDM approach enables efficient frequency domain spreading of the sequences while maintaining low peak-to-average power ratio characteristics. The MSI payload may be divided into N groups (e.g., MSI part 1, MSI part 2, and so forth) with Q bits in each group. 2Q sequences may be configured to represent Q bits of MSI payload, where each unique sequence corresponds to a specific bit pattern. For example, a first sequence may represent the first Q bits, a second sequence may represent the second Q bits, and so forth. This approach reduces payload size and correlation complexity at the UE side by enabling parallel detection of multiple information groups through sequence correlation operations. There may be M sequences before DFT spreading per OFDM symbol, where each sequence represents a group of Q bits. To increase reliability, coding and cyclic redundancy check (CRC) may be added to the information bits, and the coded bits may be mapped to the sequence selection process to provide error detection and correction capabilities.

Additionally, or alternatively, every UE monitoring for minimum system information (e.g., subset of RMSI) within a LP-PO can be configured (e.g., by the NE) with a particular sequence (e.g., a sequence of numbers) transmitted in the LP-PO. Each UE monitoring a LP-PO can be configured with a unique (e.g., within the LP-PO) sequence and the successful reception of the sequence implies successful reception of the minimum system information. Since there are limited sequences, the same sequence can be repeated in another LP-PO for another UE monitoring for minimum system information.

Additionally, or alternatively, a base sequence using a sequence identifier can be configured for a LP-PO and each UE monitoring for minimum system information can have a unique (e.g., within the LP-PO) cyclic shift generating orthogonal sequence from the base sequence. The UEs can be code division multiplexed (CDMed) using cyclic shifts for efficient resource utilization and interference mitigation.

FIG. 7 illustrates an example signaling diagram 700 in accordance with aspects of the present disclosure. In some examples, the signaling diagram 700 may implement aspects of the wireless communications system 100. For example, the signaling diagram 700 illustrates communication between a UE 104 and an NE 102, which may include or be examples of the corresponding devices as described with reference to FIGS. 1-6. Alternative examples of the following may be implemented, where some processes are performed in a different order than described or are not performed. In some cases, processes may include additional features not mentioned below, or further processes may be added.

In the example of FIG. 7, the NE 102 operates a dual-carrier configuration including a component carrier 702 configured for always-on (AO) operation or duty cycle-based transmission patterns and a component carrier 704 configured for NES with reduced transmission frequency. The component carrier 702 may implement periodic transmission windows with configurable active periods, where the transmission duty cycle may range from 20% to 90% depending on network loading conditions and energy saving requirements. The component carrier 704 may have a limited bandwidth, such as 5 MHz.

The NE 102 transmits synchronization signals and SIB0 messages using its MR via the component carrier 702 to ensure reliable initial access for all UE. During active periods, the NE 102 transmits, via the component carrier 702, complete SSB structures and full SIB0 content as defined in conventional implementations, providing sufficient processing power and computational resources to generate standard synchronization signal blocks containing PSS, SSS, and PBCH components. The SIB0 includes uplink wake-up signal configuration parameters that enable the UE 104 to determine transmission parameters for subsequent wake-up signal procedures.

After receiving the synchronization signals and SIB0, the UE 104 with no expected traffic or in idle mode reselects to the component carrier 704 and transitions from its MR 708 to its LPR 706. The UE 104 transmits an uplink wake-up signal to the NE 102 to indicate reselection to the component carrier 704 and/or to request a second portion of system information.

While operating in LPR mode, the UE 104 monitors the component carrier 704 for paging messages during LP-POs using the LPR 706 with reduced sampling rates and simplified signal processing. The NE 102 transmits paging messages via the component carrier 704 during the LP-POs. A mapping exists between uplink wake-up signal sequence or resource allocation and LP-PO groups, enabling the NE 102 to determine which paging groups require monitoring on the component carrier 704.

Upon receiving a paging message indicating incoming data or network-initiated procedures, or upon receiving MO traffic, the UE 104 reselects to the component carrier 702 and transmits a RACH message via the component carrier 702 to establish active communication with the NE 102. The distinction between uplink wake-up signals and random access channel messages becomes relevant when the UE 104 reselects between carriers, where uplink wake-up signals may indicate carrier switching and request low power paging monitoring, while random access channel messages serve the traditional purpose of connection establishment.

In some examples, the subset of RMSI is transmitted as a broadcast signal, enabling UEs that do not transmit uplink wake-up signals to receive system information when other UEs request on-demand transmission (e.g., via UL WUS or RACH). The NE 102 transmits, via the component carrier 704, paging messages using LP-POs associated with UL WUS, reducing paging transmissions for UE groups that have not indicated availability for component carrier 704 monitoring.

The component carrier 702 may be intra-band contiguous, intra-band non-contiguous, or inter-band relative to the component carrier 704, providing deployment flexibility for different spectrum allocation scenarios. The duty cycle-based operation of the component carrier 702 may require coordination between uplink wake-up signal transmission timing and active transmission windows.

In some examples, the UE 104 measures signal quality of the component carrier 704 after receiving configuration parameters from the component carrier 702, including measurement thresholds and reporting criteria. When measurement conditions are satisfied, such as a measured reference signal received power (RSRP) within a configured threshold range that ensures signal quality for low power reception, the UE 104 transmits the uplink wake-up signal indicating the transition to the component carrier 704. UEs equipped with LPR capabilities, such as IoT devices requiring extended battery life, may enter LPR mode when traffic expectations are low to achieve power savings.

FIG. 8 illustrates an example signaling diagram 800 in accordance with aspects of the present disclosure. In some examples, the signaling diagram 800 may implement aspects of the wireless communications system 100. For example, the signaling diagram 800 illustrates communication between a UE 104 and an NE 102, which may include or be examples of the corresponding devices as described with reference to FIGS. 1-7. Alternative examples of the following may be implemented, where some processes are performed in a different order than described or are not performed. In some cases, processes may include additional features not mentioned below, or further processes may be added.

In the example of FIG. 8, the NE operates a dual-carrier configuration including a component carrier 802 configured for NES with reduced transmission frequency and a component carrier 804 configured for periodic frequent common signal transmission. The component carrier 802 serves as the primary carrier for initial access and idle mode operations, while the component carrier 804 functions as the secondary carrier for data communication establishment. The component carrier 804 may operate in always-on mode with continuous transmission or may utilize duty cycle-based transmission patterns with active periods ranging from 30% to 70% of the total cycle duration to achieve additional energy savings while maintaining adequate coverage for data communication procedures.

The NE transmits synchronization signals and a subset of RMSI as defined herein via the component carrier 802 using its LPR. The subset of RMSI may include MSI part 1 and MSI part 2, which are transmitted using sequence-based transmission methods with different periodicities and orthogonal sequence selection, e.g., due to LPR constraints. The content transmitted may differ from (e.g., be reduced compared to) standard PBCH and SIB0 structures due to the simplified processing capabilities of the low power transmitter chain. The UE 104 receives these transmissions using its LPR 806 for power-efficient monitoring during initial access procedures.

The NE transmits paging messages via the component carrier 804 during LP-POs when network-initiated communication is required. The component carrier 804 employs MR capabilities for paging transmission and subsequent communication procedures. Upon receiving a paging message, the UE 104 performs reselection from the component carrier 802 to the component carrier 804, activates its MR 808 for full power operation, and transmits a RACH message via the component carrier 804 to establish active communication with the NE.

The UE 104 may utilize UL WUS to request remaining system information from the NE 102, particularly when transitioning from the primary NES carrier to the secondary carrier. The UL WUS may serve as a signaling mechanism for requesting on-demand system information during initial phases of operation on the NES carrier. The RACH transmission occurs via the component carrier 804 for establishing active communication, while the UL WUS provides a simpler signaling approach for system information requests during low power operation.

The component carrier 802 may be intra-band contiguous, intra-band non-contiguous, or inter-band relative to the component carrier 804, providing deployment flexibility for different spectrum allocation scenarios. The duty cycle-based operation of the component carrier 804 may affect random access channel transmission opportunities and timing coordination with uplink wake-up signal procedures. UEs that do not transmit UL WUS may receive system information when other UEs request on-demand transmission, e.g., if the subset of RMSI may be transmitted as a broadcast signal.

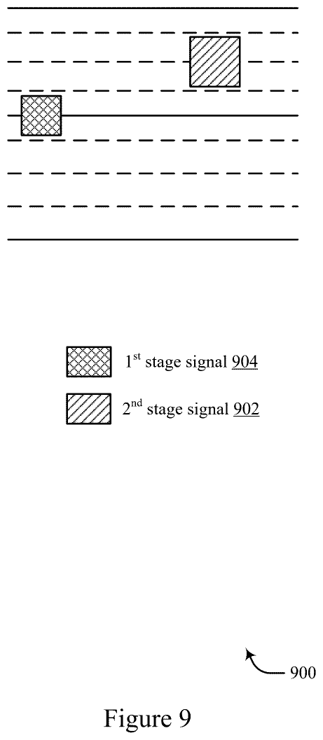

FIG. 9 illustrates an example synchronization raster 900 in accordance with aspects of the present disclosure. In some examples, the synchronization raster 900 may implement aspects of the wireless communications system 100. For example, the synchronization raster 900 illustrates communication between a UE 104 and an NE 102, which may include or be examples of the corresponding devices as described with reference to FIG. 1.

A synchronization raster defines frequency positions where a UE searches for synchronization signals during initial cell detection procedures. The raster specifies discrete frequency locations spaced at regular intervals across the frequency spectrum, enabling UEs to systematically scan for NE transmissions. In synchronization raster configurations, solid lines represent the synchronization raster grid, indicating allowed timing boundaries for synchronization signal transmission. Primary synchronization rasters define valid time locations where a first stage SS may be transmitted, while secondary synchronization rasters define valid time locations where a second stage SS may be transmitted.

Dashed lines represent intermediate timing grid lines, indicating search grid resolution or measurement raster granularity that the receiver may utilize during signal detection. Dashed lines indicate finer measurement intervals between official raster points, candidate offsets a UE may scan during synchronization, and sub-raster timing resolution used for correlation and search operations. Primary synchronization rasters define time-domain reference positions at which a first stage synchronization signal may be transmitted and/or received. These raster positions represent discrete, periodic timing locations that establish the first level of synchronization timing structure. A UE monitors these primary raster positions to detect the first stage SS and acquire an initial estimate of timing and frequency alignment for downlink reception. The primary synchronization rasters function as allowed transmission boundaries for the first-stage SS.

Secondary synchronization rasters define time-domain reference positions associated with transmission of a second-stage synchronization signal. In implementations, these rasters occur at timing locations offset from or distinct from the primary synchronization rasters. The secondary synchronization rasters provide designated time points where a UE may expect the second stage synchronization signal after acquisition of the primary stage. The second stage SS refines time and frequency synchronization and may convey additional system identification information. Intermediate dashed horizontal lines may be provided between adjacent synchronization rasters. These dashed lines represent finer-granularity timing intervals that may be utilized by a receiving device when performing synchronization detection procedures. For example, a receiver may evaluate timing hypotheses positioned at or between the defined synchronization rasters, such as at dashed-line positions, to refine time-domain correlation, mitigate timing uncertainty, or account for implementation-specific search granularity. The dashed lines may denote candidate search offsets or timing resolution within the synchronization interval, whereas the solid raster lines denote the synchronization boundaries for transmission.

The first stage signal 904 represents transmission of a first stage SS at a sparse frequency raster position. This signal is transmitted aligned to one of the primary synchronization rasters. A UE uses this signal to obtain coarse timing alignment and begin initial cell search procedures. The first stage SS may be transmitted using a sparse frequency raster, e.g., according to wider frequency spacing between candidate positions compared to conventional synchronization rasters, reducing the number of frequency positions that UEs monitor during cell search procedures. The second stage signal 902 represents transmission of a second stage SS aligned to one of the secondary synchronization rasters. The second stage SS is transmitted after the first stage SS and provides refinement information, including improved timing accuracy and system identification details for completing synchronization and initiating connection procedures. The second stage SS may be transmitted on the same raster positions as the first stage SS or on a different raster configuration.

A two-stage synchronization signal and physical broadcast channel (SS/PBCH) structure may be utilized to signal on-demand transmission of the second stage and other common signals and channels. The two-stage approach separates synchronization and system information acquisition into distinct phases, where the first phase provides basic cell detection capabilities through PSS or other first stage SS transmission and the second phase delivers complete system information including SSSs and broadcast channel content upon UE request. The two-stage approach minimizes UE power consumption by monitoring fewer synchronization raster positions while enabling network energy savings features such as on-demand SSB transmission. When the UE performs initial synchronization signal detection, band scanning across the entire frequency range may be computationally intensive, particularly when monitoring conventional synchronization rasters with frequency spacing of 1.44 MHz for frequencies below 3 GHz or 17.28 MHz for frequencies above 24 GHz. The two-stage approach reduces this computational burden by utilizing sparser frequency rasters in the first stage, where the frequency spacing between candidate positions may be increased by factors of 2, 4, or 8 compared to conventional raster configurations, thereby reducing the number of frequency positions that UEs monitor from potentially hundreds to tens of positions within a given frequency band.

In some examples, the two-stage synchronization approach separates PSS and SSS into distinct transmission phases to enable independent power management of synchronization and system information functions. The first stage transmits PSS using a sparse frequency raster with wider frequency spacing between candidate positions compared to conventional synchronization rasters. The raster spacing may be configured as multiples of conventional synchronization raster spacing, such as 2.88 MHz, 5.76 MHz, or 11.52 MHz for FR1 deployments, or 34.56 MHz, 69.12 MHz, or 138.24 MHz for FR2 deployments. The second stage transmits SSS and PBCH using either the same sparse raster positions as the first stage or a denser raster configuration within a cluster of positions around each first stage raster point, providing complete system information content including MIB parameters, cell identity information, and system frame number.

When the NE operates in low power mode, the NE transmits only the first stage SS using reduced power amplification ranging from 3-10 dB below conventional SSB transmission power and simplified signal processing that may utilize lower complexity digital signal processing algorithms, reduced sampling rates, or simplified analog front-end components. The UE detects the NE using first stage SS correlation and timing detection algorithms employing matched filtering with correlation thresholds adjusted for the reduced transmission power. Detection may require integration over multiple first stage SS transmission periods to achieve sufficient signal-to-noise ratio for reliable detection.

Upon successful first stage SS detection, the UE transmits UL WUS using pre-configuration parameters that specify transmission timing, sequence selection, power control settings, and frequency resource allocation to request on-demand second stage SS (e.g., SSS and PBCH, or PSS, SSS, and PBCH) transmission in the second stage. The MR of the NE activates after receiving the UL WUS through correlation-based detection methods and transmits the second stage SS with full power transmission capabilities and complete system information payload including cell access parameters, PLMN identity information, and scheduling information for subsequent system information blocks.

The pre-configuration of UL WUS may be provided as part of initial registration with the PLMN through higher layer signaling or may be embedded within the first stage SS transmission through sequence selection or timing parameters. The pre-configuration may contain a lookup table mapping PSS sequence identifiers to corresponding UL WUS configurations including sequence length ranging from 127 to 839 symbols, transmission slot numbers within radio frames, frame offset parameters for scheduling reference, guard period durations for interference mitigation, and power control parameters for uplink transmission. This enables UEs to determine appropriate wake-up procedures for different frequency positions or groups of frequency positions within the sparse raster configuration.

A mapping exists between first stage SS sequence identifiers (e.g., PSS sequence identifiers or dedicated first stage SS sequence identifiers) and UL WUS configuration indexes, enabling UEs to determine appropriate wake-up signal parameters based on the detected first stage SS sequence. The first stage SS sequence identifier corresponds to one of three root indices (29, 34, and 25) used in Zadoff-Chu sequence generation, where each root index provides partial Physical Cell Identity (PCI) information through modulo 3 calculation. The UL WUS configuration index references a preconfigured table containing parameters such as sequence length for correlation detection, transmission slot number within a radio frame, frame offset for scheduling reference, guard period duration for interference mitigation, and power control settings for uplink transmission. The mapping relationship may be defined as UL_WUS_config_index=f(PSS_sequence_ID, cell_specific_offset), where the cell_specific_offset parameter may be derived from higher layer signaling or system information broadcasts. The UE may store multiple UL WUS configuration tables corresponding to different frequency bands or deployment scenarios, and the first stage SS sequence identifier serves as an index selector to determine which configuration table to utilize for wake-up signal generation. The mapping may also indicate transmission timing parameters, including the number of OFDM symbols allocated for UL WUS transmission, subcarrier spacing configuration, and repetition patterns for enhanced detection reliability at the NE receiver.

In some examples, the two-stage synchronization approach may utilize a dedicated first stage SS that indicates presence of the second stage synchronization signal transmission. This dedicated first stage SS may be different from a conventional PSS. In such cases, the second stage SS includes the PSS, SSS, and PBCH. In any case, the first stage SS is transmitted on a sparse frequency raster with wider frequency spacing between candidate positions compared to conventional synchronization rasters, where the frequency spacing may be increased by factors of 2, 4, or 8 relative to standard synchronization raster configurations. The sequence of the first stage SS indicates a cluster of frequency positions for monitoring the second stage SS, where each cluster contains multiple candidate positions within a predefined frequency range around the sparse raster position.

The first stage SS may indicate time domain periodicity of the second stage SS transmission through sequence selection, enabling UEs to determine transmission timing for on-demand synchronization signal availability. The sequence may specify transmission windows and periodicities for the second stage synchronization signal in both frequency and time domains. The frequency positions for the second stage S may be determined according to the formula Seq_x=x*A+f MHz, where x represents the sequence index, A is a frequency offset parameter defining spacing between adjacent sequences, and f is the base raster frequency aligned with the synchronization raster grid. The parameter A may be derived from subcarrier spacing such that A=SCS*N_offset, where N_offset is a configurable integer value. The sequence index x may be mapped to specific cluster configurations indicating the number of candidate positions around the base raster frequency.

When the NE operates in low power mode, the NE transmits the first stage SS using reduced power and processing resources compared to conventional synchronization signal transmission. The UE detects the NE using the first stage SS through correlation-based detection methods employing matched filtering with correlation thresholds adjusted for the reduced transmission power. Upon detecting the first stage SS, the UE transmits an uplink wake-up signal using preconfigured parameters to request on-demand transmission of the second stage synchronization signal. The preconfiguration may include parameters mapping detected sequence indices to corresponding uplink wake-up signal configurations including transmission timing, sequence selection, and power control settings.

In some implementations, the first stage SS is not involved in Physical Cell Identity determination, maintaining compatibility with existing cell identity procedures. The first stage SS may utilize Zadoff-Chu sequence structures with root indices selected from a separate set to avoid interference with conventional PSS sequences, enabling reuse of existing correlation algorithms and detection thresholds at the UE receiver.

In other implementations, the first stage SS contributes to Physical Cell Identity determination, expanding the cell identity space beyond conventional limits. The first stage signal may utilize different sequences or polynomials compared to primary and SSSs, such as Gold sequences or Walsh-Hadamard sequences, to provide additional identity bits. The sequence generation may utilize different initialization parameters or generator polynomials to ensure orthogonality with existing synchronization signals.

The Physical Cell Identity calculation may be modified to incorporate the first stage signal contribution, where New PCID=3*SSS+PSS+first_stage_signal, expanding the identity space by incorporating additional bits from the first stage signal. The calculation may be implemented as New PCID=(SSS_ID*3+PSS_ID)*K+first stage_signal_ID, where K is a scaling factor and first_stage_signal ID provides additional identity information.

In another implementation, a small payload may be transmitted in the first stage to convey the PLMN identification or a portion thereof, such as the Mobile Network Code (MNC) identification. The PLMN identification enables network operators to distinguish their services from other operators within the same geographical area, while the MNC identification specifically identifies the mobile network operator within a given country code. In an implementation, PLMN identification or MNC identification may also be transmitted in the PBCH, which forms part of the SSB structure and carries the MIB containing system parameters. In another implementation, PLMN identification or MNC identification may also be transmitted using sequence-based transmission as part of the MSI part 1. The sequence-based transmission approach utilizes orthogonal sequences to represent different information bits, reducing decoding complexity at the UE receiver while enabling efficient transmission of network identification parameters.

In some implementations, the UE may transmit the uplink wake-up signal to request on-demand SSB or partial SSB transmission after completing cell identification and PLMN selection procedures. This approach ensures that only UEs that have successfully verified network association through PLMN selection may transmit wake-up signals, preventing unauthorized or random wake-up signal transmissions that could interfere with network energy savings operations. The cell identification process involves detection and correlation of PSS and SSS to determine the Physical Cell Identity, while PLMN selection enables the UE to verify that the detected cell belongs to an authorized network operator.

The two-stage synchronization approach may be implemented in capacity enhancement scenarios where network energy savings cells provide additional capacity through traffic offloading from heavily loaded cells. The anchor cell operates with always-on SSB transmission or extended periodicity to maintain continuous coverage, while NES cells operate with reduced transmission frequency to achieve energy savings during low traffic conditions.

In capacity boost scenarios with offloading, Reference Signal Received Power (RSRP) measurements of an anchor cell are used to determine whether measuring a NES cell for offloading purposes provides sufficient benefit. The NES cells and the anchor cell have overlapping coverage areas, enabling UEs to maintain connectivity through the anchor cell while accessing energy-efficient services through NES cells when traffic conditions warrant offloading. The UE receives one or multiple WUS configurations from the anchor cell through higher layer signaling such as RRC messages or system information broadcasts, enabling the UE to determine appropriate wake-up procedures for different NES cells within the coverage area.

Each WUS configuration includes an SSB index of the anchor cell, an RSRP threshold of the anchor cell, NES cell identification, and a WUS resource allocation. The network exploits deployment knowledge including cell coverage patterns, interference characteristics, and traffic distribution to optimize wake-up signal resource allocation and threshold parameters for efficient offloading decisions. The UE may transmit a WUS on a WUS resource for a NES cell if RSRP of an associated SSB of the anchor cell is less than a corresponding RSRP threshold. This condition-based transmission approach ensures that wake-up signals are transmitted only when signal quality conditions indicate potential benefit from NES cell activation, thereby minimizing unnecessary wake-up signal overhead and preserving network energy savings.

In alternative deployment scenarios, a NES cell may function as either a capacity boosting cell or a coverage providing cell, operating with extended SSB burst transmission periodicity such as 160 ms to achieve energy savings while maintaining service availability. The NES cells and anchor cells may not have overlapping coverage areas, requiring independent operation and potentially different wake-up signal configuration approaches compared to overlapping coverage scenarios. A WUS configuration may be transmitted from the anchor cell or from a corresponding NES cell itself, providing flexibility in configuration delivery based on coverage patterns and network architecture.

Each WUS configuration includes an RSRP threshold of a NES cell, NES cell identification, and a WUS resource allocation, enabling UEs to determine wake-up signal transmission conditions based on measured signal quality relative to the NES cell rather than an anchor cell. If a UE camping on the NES cell experiences good radio geometry with sufficient signal quality, the UE does not transmit a WUS, allowing the cell to maintain energy-efficient operation. If a UE camping on the NES cell experiences poor radio geometry with degraded signal conditions, the UE transmits the WUS to request more frequent SSB transmissions before attempting network access to the NES cell. A coverage limited UE may transmit a WUS on a WUS resource for a NES cell if RSRP of the NES cell is less than a corresponding RSRP threshold and network access is expected within a predetermined time interval. This dual-condition approach enables wake-up signal transmission based on both current radio conditions and anticipated traffic requirements, allowing proactive activation of NES cells when network access is imminent while maintaining energy savings during periods of no expected activity. The geometry-based WUS transmission approach balances energy savings with access latency by providing additional SSB transmissions only when radio conditions require enhanced synchronization support.

The two-stage synchronization approach may be implemented in standalone NES cell deployments where NES cells operate independently without overlapping coverage from anchor cells. In such deployments, specialized wake-up signal procedures and validity area definitions are required to maintain network access capabilities while preserving energy savings benefits.

For standalone NES cell deployments, a validity area or region may be defined using Radio Access Network (RAN) area or tracking area identifiers to establish geographical boundaries for wake-up signal authorization. When a UE loses connection to a cell within the RAN area or tracking area and is out of coverage, the UE may be authorized to transmit uplink wake-up signals according to the wake-up signal configuration. The wake-up signal configuration, including applicable RAN area or tracking area parameters, may be indicated when the UE is assigned a UE registration area or RAN notification area that includes the NES RAN area or tracking area in the list of area identities. This approach ensures that wake-up signal transmission authorization is geographically bounded and tied to specific network registration procedures, preventing unauthorized wake-up signal transmissions outside designated coverage areas while enabling coverage-limited access within defined regions.

Coarse synchronization may be required to enable efficient wake-up signal detection, as the NES NE receiver would otherwise need to remain active continuously searching for wake-up signal preambles, thereby negating energy savings benefits. The NE may maintain a downlink synchronization validity duration since the last downlink synchronization to a cell in the NES RAN area or tracking area, or may utilize Global Navigation Satellite System (GNSS) based synchronization as implemented in Non-Terrestrial Network (NTN) deployments to provide coarse transmit timing reference for wake-up signal transmission during the validity duration. The CP and guard time of the wake-up signal preamble may be configured larger than conventional RACH parameters to accommodate uncertainties in preamble reception timing at the NE. The extended CP and guard time parameters compensate for timing uncertainties that may arise from reduced synchronization frequency in energy savings deployments, ensuring reliable wake-up signal detection despite relaxed timing constraints.

Additionally, a wireless communications system may implement PLMN-scrambled synchronization signals for authorized wake-up signal transmission. Network operator identification may be embedded directly within synchronization signal generation to enable selective wake-up signal authorization based on network association. The generation of PSS and SSS may be scrambled with PLMN identification or part of the PLMN identification, such as Mobile Network Code (MNC) identification, enabling UEs belonging to a specific PLMN or MNC to transmit uplink wake-up signals to request on-demand system information or SSB transmission. This scrambling approach provides network-specific synchronization signals that may be detected and decoded only by UEs associated with the corresponding network operator, thereby preventing unauthorized wake-up signal transmissions from ULEs belonging to different network operators or roaming ULEs without appropriate authorization.

PLMN-scrambled synchronization signal generation involves a systematic procedure that takes PLMN identification as an input parameter, where the PLMN identification consists of a Mobile Country Code (MCC) and Mobile Network Code (MNC) that uniquely identify the network operator within a specific country or geographical region. Standard PSS and SSS sequences are generated according to conventional 3GPP specifications, where PSS utilizes Zadoff-Chu sequences with length 127 and root indices corresponding to Physical Cell Identity values modulo 3, and SSS employs Gold sequences of length 127 generated using two m-sequences with initialization parameters derived from the Physical Cell Identity. A scrambling sequence is derived from the PLMN identification using cryptographic or pseudo-random generation methods to create network-specific scrambling patterns.

The scrambling sequence generation may utilize a cryptographic hash function such as SHA-256 or a Pseudo-Random Number Generator (PRNG) seeded with the PLMN identification to generate a pseudo-random sequence of length 127. The hash function approach provides deterministic scrambling sequence generation that may be reproduced at both transmitter and receiver sides using the same PLMN identification input. The scrambling sequence may be binary or complex depending on the scrambling method implementation, where scrambling by rotating only the phase preserves orthogonality properties of the original synchronization sequences while maintaining correlation characteristics needed for reliable detection and providing network-specific identification. XOR operation for binary sequences or complex multiplication for complex sequences may be applied between the standard PSS/SSS and the scrambling sequence, where XOR operation provides simple binary scrambling suitable for phase-based scrambling implementations, while complex multiplication enables amplitude and phase scrambling for enhanced security and network differentiation.

The mathematical formulation for PLMN-scrambled synchronization signal generation may be expressed where S_PSS(n) represents the standard PSS sequence generated according to conventional Zadoff-Chu sequence generation procedures with appropriate root index selection based on Physical Cell Identity, S_SSS(n) represents the standard SSS sequence generated using Gold sequence generation with m-sequence initialization parameters derived from Physical Cell Identity and slot number within the radio frame, and S_PLMN(n) represents the scrambling sequence derived from PLMN identification using the cryptographic hash or PRNG approach, where n represents the sequence index ranging from 0 to 126 for length-127 sequences. The scrambled synchronization sequences are calculated as scrambled PSS: S′_PSS(n)=S_PSS(n) x S_PLMN(n) and scrambled SSS: S′_SSS(n)=S_SSS(n)×S_PLMN(n), where the multiplication operation may be complex multiplication for complex sequences or XOR operation for binary sequences, applying the same scrambling operation to maintain consistency in network-specific scrambling across both synchronization signals.

An implementation example may utilize PLMN identification where MCC=262 and MNC=01, resulting in PLMN=“26201” representing a specific network operator identification. SHA-256 hash of “26201” may be used to seed a PRNG, where the hash function converts the PLMN string into a deterministic seed value for initializing the pseudo-random number generator for consistent scrambling sequence generation. A pseudo-random complex sequence of length 127 may be generated using the seeded PRNG, where each complex value may be represented as e\hat{ }(jθ) with θ being a pseudo-random phase angle, enabling phase-only scrambling that preserves the amplitude characteristics of the original synchronization sequences. Element-wise multiplication between the standard PSS and SSS sequences and the generated scrambling sequence produces the final PLMN-scrambled synchronization signals, where the element-wise multiplication operation ensures that each subcarrier position within the synchronization sequences receives network-specific scrambling, enabling UEs to detect and decode only synchronization signals from their associated network operator while maintaining the correlation properties needed for reliable synchronization and cell identification procedures.

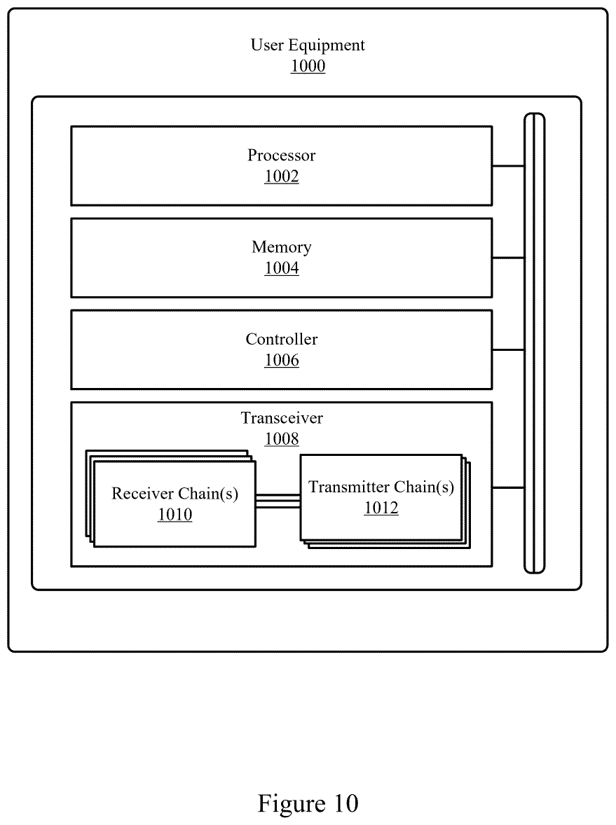

FIG. 10 illustrates an example of a UE 1000 in accordance with aspects of the present disclosure. The ULE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a central processing unit (CPU), an ASIC, a field-programmable gate-array (FPGA), or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the UE 1000 to perform various functions of the present disclosure.

The memory 1004 may include volatile or non-volatile memory. The memory 1004 may store computer-readable, computer-executable code including instructions when executed by the processor 1002 cause the UE 1000 to perform various functions described herein. The code may be stored in a non-transitory computer-readable medium such as the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the UE 1000 to perform one or more of the functions described herein (e.g., executing, by the processor 1002, instructions stored in the memory 1004). For example, the processor 1002 may support wireless communication at the UE 1000 in accordance with examples as disclosed herein. The UE 1000 may be configured to or operable to support a means for receiving, from a network entity via a first carrier, one or more synchronization signals and a first portion of minimum system information, transmitting an uplink wake-up signal, where the uplink wake-up signal is associated with a public land mobile network of the network entity, and receiving a second portion of the minimum system information via a second carrier. In this manner, the UE 1000 enables network energy savings by supporting on-demand system information transmission while maintaining reliable initial access capabilities through LPR operation.

Additionally, or alternatively, the UE 1000 may be configured to support any one or combination of receiving a configuration for the uplink wake-up signal together with cell selection information and cell access related information. This aspect prevents unauthorized wake-up signal transmissions by ensuring only UEs that have completed cell selection and PLMN verification procedures may request on-demand system information, thereby preserving network energy savings and preventing interference from non-associated devices.

Additionally, or alternatively, the UE 1000 may be configured to support any one or combination of the first and second carriers are the same carrier configured for a network energy savings mode with reduced transmission frequency, the synchronization signals and the first portion of minimum system information are received using a LPR, monitoring, using the LPR, for at least one paging message during one or more low power paging occasions, where the one or more low power paging occasions are associated with the uplink wake-up signal, in response to successful reception of the at least one paging message, transmitting a request for the second portion of the minimum system information, where the request for the second portion of the minimum system information is included in one of the uplink wake-up signal or a random access channel message, and activating a MR based at least in part on transmitting the uplink wake-up signal, where the second portion of minimum system information is received using the MR. This aspect reduces UE power consumption by utilizing LPR components for monitoring and initial access procedures while activating MR capabilities only when network communication is required.

Additionally, or alternatively, the UE 1000 may be configured to support any one or combination of the first carrier is configured for periodic frequent common signal transmission and the second carrier is configured for a network energy savings mode with reduced transmission frequency, the synchronization signals and first portion of minimum system information are received using a MR, and the uplink wake-up signal is transmitted via the second carrier using the MR of the UE to indicate reselection of the UE to the second carrier. This aspect enables flexible carrier management by allowing UEs to transition between always-on carriers for reliable initial access and energy-saving carriers for power-efficient monitoring during idle periods.

Additionally, or alternatively, the UE 1000 may be configured to support any one or combination of monitoring the second carrier for at least one paging message during one or more low power paging occasions using a LPR, where the one or more low power paging occasions are associated with the uplink wake-up signal, and in response to successful reception of the at least one paging message, transmitting a random access channel message via the first carrier using the LPR. This aspect optimizes power consumption by utilizing LPR components for paging monitoring while maintaining the capability to establish active communication through the always-on carrier when network access is required.

Additionally, or alternatively, the UE 1000 may be configured to support any one or combination of the first carrier is configured for network energy savings mode with reduced transmission frequency and the second carrier is configured for periodic frequent common signal transmission, the synchronization signals and the first portion of minimum system information are received using a LPR, monitoring the second carrier for at least one paging message during one or more low power paging occasions using the LPR, where the one or more low power paging occasions are associated with the uplink wake-up signal, and in response to successful reception of the at least one paging message, transmitting a random access channel message via the second carrier using a MR. This aspect provides enhanced battery life for IoT devices by enabling initial access through energy-saving carriers while maintaining reliable connection establishment capabilities through always-on carriers for data communication.

Additionally, or alternatively, the UE 1000 may support at least one memory (e.g., the memory 1004) and at least one processor (e.g., the processor 1002) coupled with the at least one memory and configured to cause the UE to 1000 to receive, from a network entity via a first carrier, one or more synchronization signals and a first portion of minimum system information, transmit an uplink wake-up signal, where the uplink wake-up signal is associated with a public land mobile network of the network entity, and receive a second portion of the minimum system information via a second carrier. In this manner, the UE 1000 enables network energy savings by supporting on-demand system information transmission while maintaining reliable initial access capabilities through LPR operation.

Additionally, or alternatively, the UE 1000 may be configured to support any one or combination of the at least one processor is further configured to cause the UE to receive a configuration for the uplink wake-up signal together with cell selection information and cell access related information. This aspect prevents unauthorized wake-up signal transmissions by ensuring only UEs that have completed cell selection and PLMN verification procedures may request on-demand system information, thereby preserving network energy savings and preventing interference from non-associated devices.

Additionally, or alternatively, the UE 1000 may be configured to support any one or combination of the first and second carriers are the same carrier configured for a network energy savings mode with reduced transmission frequency, the synchronization signals and the first portion of minimum system information are received using a LPR, and the at least one processor is further configured to cause the UE to monitor, using the LPR, for at least one paging message during one or more low power paging occasions, where the one or more low power paging occasions are associated with the uplink wake-up signal, in response to successful reception of the at least one paging message, transmit a request for the second portion of the minimum system information, where the request for the second portion of the minimum system information is included in one of the uplink wake-up signal or a random access channel message, and activate a MR based at least in part on transmitting the uplink wake-up signal, where the second portion of minimum system information is received using the MR. This aspect reduces UE power consumption by utilizing LPR components for monitoring and initial access procedures while activating MR capabilities only when network communication is required.

Additionally, or alternatively, the UE 1000 may be configured to support any one or combination of the first carrier is configured for periodic frequent common signal transmission and the second carrier is configured for a network energy savings mode with reduced transmission frequency, the synchronization signals and first portion of minimum system information are received using a MR, and the uplink wake-up signal is transmitted via the second carrier using the MR of the UE to indicate reselection of the UE to the second carrier. This aspect enables flexible carrier management by allowing UEs to transition between always-on carriers for reliable initial access and energy-saving carriers for power-efficient monitoring during idle periods.

Additionally, or alternatively, the UE 1000 may be configured to support any one or combination of the at least one processor is further configured to cause the UE to monitor the second carrier for at least one paging message during one or more low power paging occasions using a LPR, where the one or more low power paging occasions are associated with the uplink wake-up signal, and in response to successful reception of the at least one paging message, transmit a random access channel message via the first carrier using the LPR. This aspect optimizes power consumption by utilizing LPR components for paging monitoring while maintaining the capability to establish active communication through the always-on carrier when network access is required.

Additionally, or alternatively, the UE 1000 may be configured to support any one or combination of the first carrier is configured for network energy savings mode with reduced transmission frequency and the second carrier is configured for periodic frequent common signal transmission, the synchronization signals and the first portion of minimum system information are received using a LPR, and the at least one processor is further configured to cause the UE to monitor the second carrier for at least one paging message during one or more low power paging occasions using the LPR, where the one or more low power paging occasions are associated with the uplink wake-up signal, and in response to successful reception of the at least one paging message, transmit a random access channel message via the second carrier using a MR. This aspect provides enhanced battery life for IoT devices by enabling initial access through energy-saving carriers while maintaining reliable connection establishment capabilities through always-on carriers for data communication.

The controller 1006 may manage input and output signals for the UE 1000. The controller 1006 may also manage peripherals not integrated into the UE 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the UE 1000 may include at least one transceiver 1008. In some other implementations, the UE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas to receive a signal over the air or wireless medium. The receiver chain 1010 may include at least one amplifier (e.g., a low-noise amplifier (LNA)) configured to amplify the received signal. The receiver chain 1010 may include at least one demodulator configured to demodulate the receive signal and obtain the transmitted data by reversing the modulation technique applied during transmission of the signal. The receiver chain 1010 may include at least one decoder for decoding the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature AM (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

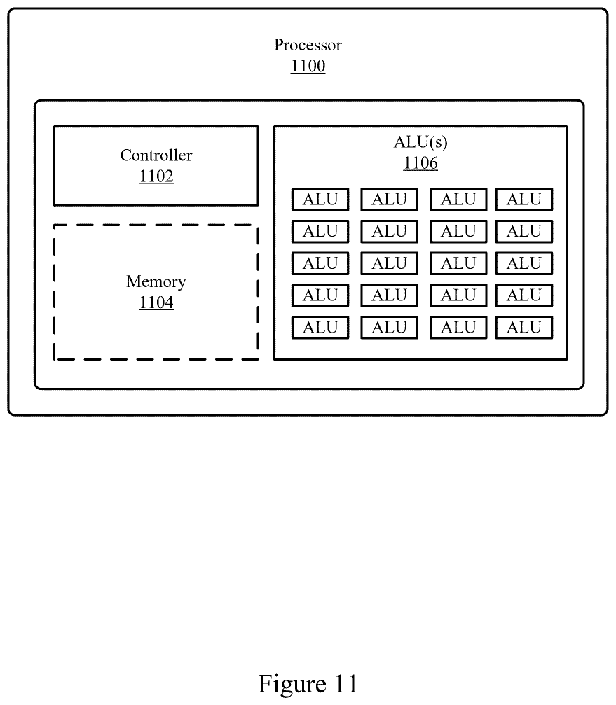

FIG. 11 illustrates an example of a processor 1100 in accordance with aspects of the present disclosure. The processor 1100 may be an example of a processor configured to perform various operations in accordance with examples as described herein. The processor 1100 may include a controller 1102 configured to perform various operations in accordance with examples as described herein. The processor 1100 may optionally include at least one memory 1104, which may be, for example, an L1/L2/L3 cache. Additionally, or alternatively, the processor 1100 may optionally include one or more arithmetic-logic units (ALUs) 1106. One or more of these components may be in electronic communication or otherwise coupled (e.g., operatively, communicatively, functionally, electronically, electrically) via one or more interfaces (e.g., buses).

The processor 1100 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1100) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1102 may be configured to manage and coordinate various operations (e.g., signaling, receiving, obtaining, retrieving, transmitting, outputting, forwarding, storing, determining, identifying, accessing, writing, reading) of the processor 1100 to cause the processor 1100 to support various operations in accordance with examples as described herein. For example, the controller 1102 may operate as a control unit of the processor 1100, generating control signals that manage the operation of various components of the processor 1100. These control signals include enabling or disabling functional units, selecting data paths, initiating memory access, and coordinating timing of operations.

The controller 1102 may be configured to fetch (e.g., obtain, retrieve, receive) instructions from the memory 1104 and determine subsequent instruction(s) to be executed to cause the processor 1100 to support various operations in accordance with examples as described herein. The controller 1102 may be configured to track memory addresses of instructions associated with the memory 1104. The controller 1102 may be configured to decode instructions to determine the operation to be performed and the operands involved. For example, the controller 1102 may be configured to interpret the instruction and determine control signals to be output to other components of the processor 1100 to cause the processor 1100 to support various operations in accordance with examples as described herein. Additionally, or alternatively, the controller 1102 may be configured to manage flow of data within the processor 1100. The controller 1102 may be configured to control transfer of data between registers, ALUs 1106, and other functional units of the processor 1100.

The memory 1104 may include one or more caches (e.g., memory local to or included in the processor 1100 or other memory, such as RAM, ROM, DRAM, SDRAM, SRAM, MRAM, flash memory, etc. In some implementations, the memory 1104 may reside within or on a processor chipset (e.g., local to the processor 1100). In some other implementations, the memory 1104 may reside external to the processor chipset (e.g., remote to the processor 1100).

The memory 1104 may store computer-readable, computer-executable code including instructions that, when executed by the processor 1100, cause the processor 1100 to perform various functions described herein. The code may be stored in a non-transitory computer-readable medium such as system memory or another type of memory. The controller 1102 and/or the processor 1100 may be configured to execute computer-readable instructions stored in the memory 1104 to cause the processor 1100 to perform various functions. For example, the processor 1100 and/or the controller 1102 may be coupled with or to the memory 1104, the processor 1100, and the controller 1102, and may be configured to perform various functions described herein. In some examples, the processor 1100 may include multiple processors and the memory 1104 may include multiple memories. One or more of the multiple processors may be coupled with one or more of the multiple memories, which may, individually or collectively, be configured to perform various functions herein.

The one or more ALUs 1106 may be configured to support various operations in accordance with examples as described herein. In some implementations, the one or more ALUs 1106 may reside within or on a processor chipset (e.g., the processor 1100). In some other implementations, the one or more ALUs 1106 may reside external to the processor chipset (e.g., the processor 1100). One or more ALUs 1106 may perform one or more computations such as addition, subtraction, multiplication, and division on data. For example, one or more ALUs 1106 may receive input operands and an operation code, which determines an operation to be executed. One or more ALUs 1106 may be configured with a variety of logical and arithmetic circuits, including adders, subtractors, shifters, and logic gates, to process and manipulate the data according to the operation. Additionally, or alternatively, the one or more ALUs 1106 may support logical operations such as AND, OR, exclusive-OR (XOR), not-OR (NOR), and not-AND (NAND), enabling the one or more ALUs 1106 to handle conditional operations, comparisons, and bitwise operations.

The processor 1100 may support wireless communication in accordance with examples as disclosed herein. The processor 1100 may be configured to or operable to support at least one controller (e.g., the controller 1102) coupled with at least one memory (e.g., the memory 1104) and configured to cause the processor to 1100 to receive, from a network entity via a first carrier, one or more synchronization signals and a first portion of minimum system information, transmit an uplink wake-up signal, where the uplink wake-up signal is associated with a public land mobile network of the network entity, and receive a second portion of the minimum system information via a second carrier. In this manner, the processor 1100 enables network energy savings by supporting on-demand system information transmission while maintaining reliable initial access capabilities through LPR operation.

Additionally, or alternatively, the processor 1100 may be configured to or operable to support any one or combination of receiving a configuration for the uplink wake-up signal together with cell selection information and cell access related information. This aspect prevents unauthorized wake-up signal transmissions by ensuring only UEs that have completed cell selection and PLMN verification procedures may request on-demand system information, thereby preserving network energy savings and preventing interference from non-associated devices.

Additionally, or alternatively, the processor 1100 may be configured to or operable to support any one or combination of the first and second carriers are the same carrier configured for a network energy savings mode with reduced transmission frequency, the synchronization signals and the first portion of minimum system information are received using a LPR, and the processor 1100 is further configured to cause the UE to monitor, using the LPR, for at least one paging message during one or more low power paging occasions, where the one or more low power paging occasions are associated with the uplink wake-up signal, in response to successful reception of the at least one paging message, transmit a request for the second portion of the minimum system information, where the request for the second portion of the minimum system information is included in one of the uplink wake-up signal or a random access channel message, and activate a MR based at least in part on transmitting the uplink wake-up signal, where the second portion of minimum system information is received using the MR. This aspect reduces UE power consumption by utilizing LPR components for monitoring and initial access procedures while activating MR capabilities only when network communication is required.

Additionally, or alternatively, the processor 1100 may be configured to or operable to support any one or combination of the first carrier is configured for periodic frequent common signal transmission and the second carrier is configured for a network energy savings mode with reduced transmission frequency, the synchronization signals and first portion of minimum system information are received using a MR, and the uplink wake-up signal is transmitted via the second carrier using the MR of the UE to indicate reselection of the UE to the second carrier. This aspect enables flexible carrier management by allowing UEs to transition between always-on carriers for reliable initial access and energy-saving carriers for power-efficient monitoring during idle periods.

Additionally, or alternatively, the processor 1100 may be configured to or operable to support any one or combination of monitoring the second carrier for at least one paging message during one or more low power paging occasions using a LPR, where the one or more low power paging occasions are associated with the uplink wake-up signal, and in response to successful reception of the at least one paging message, transmitting a RACH message via the first carrier using the LPR. This aspect optimizes power consumption by utilizing LPR components for paging monitoring while maintaining the capability to establish active communication through the always-on carrier when network access is required.

Additionally, or alternatively, the processor 1100 may be configured to or operable to support any one or combination of the first carrier is configured for network energy savings mode with reduced transmission frequency and the second carrier is configured for periodic frequent common signal transmission, the synchronization signals and the first portion of minimum system information are received using a LPR, and the processor 1100 is further configured to cause the UE to monitor the second carrier for at least one paging message during one or more low power paging occasions using the LPR, where the one or more low power paging occasions are associated with the uplink wake-up signal, and in response to successful reception of the at least one paging message, transmit a random access channel message via the second carrier using a MR. This aspect provides enhanced battery life for IoT devices by enabling initial access through energy-saving carriers while maintaining reliable connection establishment capabilities through always-on carriers for data communication.

The processor 1100 may support wireless communication in accordance with examples as disclosed herein. The processor 1100 may be configured to or operable to support at least one controller (e.g., the controller 1102) coupled with at least one memory (e.g., the memory 1104) and configured to cause the processor to 1100 to receive, from a network entity via a first carrier, one or more synchronization signals and a first portion of minimum system information, transmit an uplink wake-up signal, where the uplink wake-up signal is associated with a public land mobile network of the network entity, and receive a second portion of the minimum system information via a second carrier. In this manner, the processor 1100 enables network energy savings by supporting on-demand system information transmission while maintaining reliable initial access capabilities through LPR operation.

Additionally, or alternatively, the processor 1100 may be configured to or operable to support any one or combination of receiving a configuration for the uplink wake-up signal together with cell selection information and cell access related information. This aspect prevents unauthorized wake-up signal transmissions by ensuring only UEs that have completed cell selection and PLMN verification procedures may request on-demand system information, thereby preserving network energy savings and preventing interference from non-associated devices.

Additionally, or alternatively, the processor 1100 may be configured to or operable to support any one or combination of the first and second carriers are the same carrier configured for a network energy savings mode with reduced transmission frequency, the synchronization signals and the first portion of minimum system information are received using a LPR, and the processor 1100 is further configured to cause the UE to monitor, using the LPR, for at least one paging message during one or more low power paging occasions, where the one or more low power paging occasions are associated with the uplink wake-up signal, in response to successful reception of the at least one paging message, transmit a request for the second portion of the minimum system information, where the request for the second portion of the minimum system information is included in one of the uplink wake-up signal or a random access channel message, and activate a MR based at least in part on transmitting the uplink wake-up signal, where the second portion of minimum system information is received using the MR. This aspect reduces UE power consumption by utilizing LPR components for monitoring and initial access procedures while activating MR capabilities only when network communication is required.

Additionally, or alternatively, the processor 1100 may be configured to or operable to support any one or combination of the first carrier is configured for periodic frequent common signal transmission and the second carrier is configured for a network energy savings mode with reduced transmission frequency, the synchronization signals and first portion of minimum system information are received using a MR, and the uplink wake-up signal is transmitted via the second carrier using the MR of the UE to indicate reselection of the UE to the second carrier. This aspect enables flexible carrier management by allowing UEs to transition between always-on carriers for reliable initial access and energy-saving carriers for power-efficient monitoring during idle periods.

Additionally, or alternatively, the processor 1100 may be configured to or operable to support any one or combination of monitoring the second carrier for at least one paging message during one or more low power paging occasions using a LPR, where the one or more low power paging occasions are associated with the uplink wake-up signal, and in response to successful reception of the at least one paging message, transmitting a RACH message via the first carrier using the LPR. This aspect optimizes power consumption by utilizing LPR components for paging monitoring while maintaining the capability to establish active communication through the always-on carrier when network access is required.

Additionally, or alternatively, the processor 1100 may be configured to or operable to support any one or combination of the first carrier is configured for network energy savings mode with reduced transmission frequency and the second carrier is configured for periodic frequent common signal transmission, the synchronization signals and the first portion of minimum system information are received using a LPR, and the processor 1100 is further configured to cause the UE to monitor the second carrier for at least one paging message during one or more low power paging occasions using the LPR, where the one or more low power paging occasions are associated with the uplink wake-up signal, and in response to successful reception of the at least one paging message, transmit a random access channel message via the second carrier using a MR. This aspect provides enhanced battery life for IoT devices by enabling initial access through energy-saving carriers while maintaining reliable connection establishment capabilities through always-on carriers for data communication.

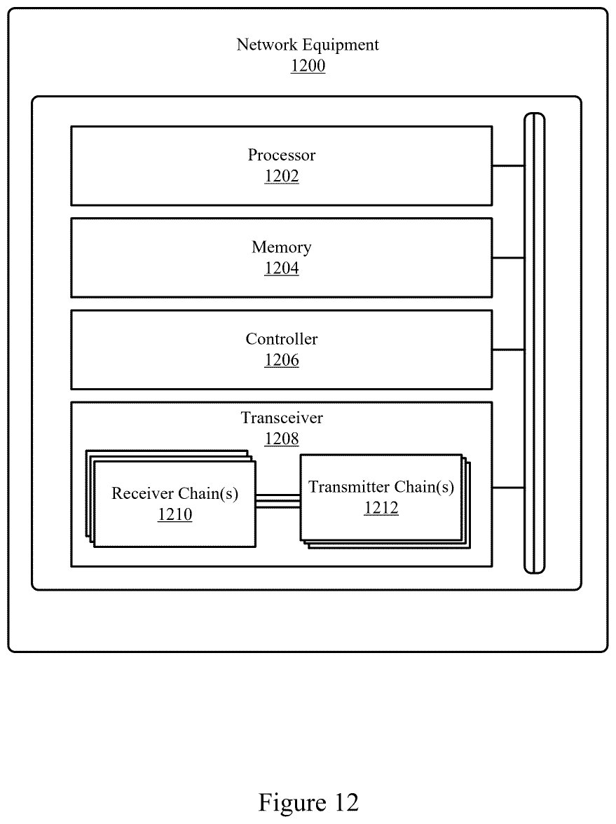

FIG. 12 illustrates an example of an NE 1200 in accordance with aspects of the present disclosure. The NE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a DSP, an ASIC, or other programmable logic device, or any combination thereof configured as or otherwise supporting a means for performing the functions described in the present disclosure.

The processor 1202 may include an intelligent hardware device (e.g., a general-purpose processor, a DSP, a CPU, an ASIC, an FPGA, or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the NE 1200 to perform various functions of the present disclosure.

The memory 1204 may include volatile or non-volatile memory. The memory 1204 may store computer-readable, computer-executable code including instructions when executed by the processor 1202 cause the NE 1200 to perform various functions described herein. The code may be stored in a non-transitory computer-readable medium such as the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the NE 1200 to perform one or more of the functions described herein (e.g., executing, by the processor 1202, instructions stored in the memory 1204). For example, the processor 1202 may support wireless communication at the NE 1200 in accordance with examples as disclosed herein. The NE 1200 may be configured to or operable to support a means for transmitting, using a LPR, one or more synchronization signals and a first portion of minimum system information via a first carrier, receiving an uplink wake-up signal from a user equipment, where the uplink wake-up signal is associated with a public land mobile network of the NE, activating a MR of the NE in response to receiving the uplink wake-up signal, and transmitting, using the MR, a second portion of the minimum system information via a second carrier. In this manner, the NE 1200 enables network energy savings during no-load and low-load conditions by reducing transmission frequency of always-on common channels while maintaining the ability to provide system information when requested by authorized UEs.

Additionally, or alternatively, the NE 1200 may be configured to support any one or combination of transmitting a configuration for the uplink wake-up signal together with cell selection information and cell access related information to restrict transmission of the wake-up signal to UEs associated with the PLMN of the NE. This aspect prevents unauthorized wake-up signal transmissions from random ULEs by requiring completion of cell selection and PLMN verification procedures before wake-up signal authorization, thereby preserving energy savings objectives and preventing interference from non-associated devices.

Additionally, or alternatively, the NE 1200 may be configured to support any one or combination of the first and second carriers are the same carrier configured for a network energy savings mode with reduced transmission frequency, transmitting, using the LPR, at least one paging message during one or more low power paging occasions, where the one or more low power paging occasions are associated with the uplink wake-up signal, and receiving, in response to the at least one paging message, a request for the second portion of the minimum system information, where the request for the second portion of the minimum system information is included in one of the uplink wake-up signal or a random access channel message. This aspect achieves maximum energy savings by utilizing a single carrier for all low power operations while maintaining on-demand system information delivery capabilities through coordinated paging and wake-up signal procedures.

Additionally, or alternatively, the NE 1200 may be configured to support any one or combination of the first carrier is configured for periodic frequent common signal transmission and the second carrier is configured for a network energy savings mode with reduced transmission frequency, transmitting, using the LPR, at least one paging message via the second carrier during one or more low power paging occasions, and receiving a RACH message via the first carrier based at least in part on the at least one paging message. This aspect enables flexible deployment scenarios by providing reliable initial access through always-on carriers while achieving energy savings through dedicated low power carriers for paging and wake-up procedures.

Additionally, or alternatively, the NE 1200 may be configured to support any one or combination of the uplink wake-up signal is received via the second carrier and indicates at least one of reselection of the UE to the second carrier or a request for the second portion of the minimum system information. This aspect optimizes carrier utilization by enabling UEs to signal both carrier reselection and system information requests through a single wake-up signal transmission, reducing signaling overhead while maintaining energy-efficient operation.

Additionally, or alternatively, the NE 1200 may be configured to support any one or combination of the first carrier is configured for a network energy savings mode with reduced transmission frequency and the second carrier is configured for periodic frequent common signal transmission, transmitting, using the LPR, at least one paging message via the second carrier during one or more low power paging occasions, and receiving a RACH message via the second carrier based at least in part on the at least one paging message. This aspect provides enhanced coverage scenarios by utilizing energy-saving carriers for initial access while maintaining reliable connection establishment through always-on carriers for subsequent data communication procedures.

Additionally, or alternatively, the NE 1200 may be configured to support any one or combination of the first portion of minimum system information includes a plurality of information segments transmitted according to orthogonal sequence selection, where each information segment has a respective transmission periodicity. This aspect reduces decoding complexity at UE receivers while enabling flexible power management by transmitting time-sensitive information more frequently than static configuration parameters.

Additionally, or alternatively, the NE 1200 may be configured to support any one or combination of the plurality of information segments includes at least a first information segment including at least one of a cell barred indication, an SSB subcarrier offset parameter, or system frame number information, and a second information segment including at least one of cell selection information, cell access related information, or uplink wake-up signal configuration parameters. This aspect optimizes power consumption and access latency by prioritizing transmission of essential access control information while providing comprehensive system information through segmented delivery.

Additionally, or alternatively, the NE 1200 may be configured to support any one or combination of transmitting the one or more synchronization signals comprises transmitting a first stage synchronization signal on a sparse frequency raster using the low power radio, and transmitting a second stage synchronization signal using the main radio in response to the uplink wake-up signal. This aspect reduces UE power consumption during cell search procedures by minimizing the number of frequency positions that must be monitored while enabling on-demand delivery of complete synchronization information.

Additionally, or alternatively, the NE 1200 may be configured to support any one or combination of the first stage synchronization signal comprises a primary synchronization signal and the second stage synchronization signal comprises a secondary synchronization signal and a physical broadcast channel. This aspect enables independent power management of synchronization functions by separating basic cell detection from complete system information delivery, allowing network energy savings while maintaining UE synchronization capabilities.

Additionally, or alternatively, the NE 1200 may be configured to support any one or combination of the first stage synchronization signal indicates presence of the second stage synchronization signal and uses a sequence that indicates a cluster of frequency positions for monitoring the second stage synchronization signal, and the second stage synchronization signal comprises a primary synchronization signal, a secondary synchronization signal, and a physical broadcast channel. This aspect provides enhanced flexibility in synchronization signal deployment by enabling dedicated first stage signals that guide UEs to appropriate frequency clusters for complete synchronization signal reception.

Additionally, or alternatively, the NE 1200 may be configured to support any one or combination of the one or more synchronization signals are scrambled with public land mobile network identification information using scrambling sequences derived from the PLMN identification information. This aspect provides network-specific synchronization signals that prevent unauthorized wake-up signal transmissions from UEs belonging to different network operators while maintaining correlation properties needed for reliable synchronization and cell identification procedures.

Additionally, or alternatively, the NE 1200 may support at least one memory (e.g., the memory 1204) and at least one processor (e.g., the processor 1202) coupled with the at least one memory and configured to cause the NE 1200 to transmit, using a low power radio, one or more synchronization signals and a first portion of minimum system information via a first carrier, receive an uplink wake-up signal from a user equipment, where the uplink wake-up signal is associated with a public land mobile network of the NE, activate a main radio of the NE in response to receiving the uplink wake-up signal, and transmit, using the main radio, a second portion of the minimum system information via a second carrier. In this manner, the NE 1200 enables network energy savings during no-load and low-load conditions by reducing transmission frequency of always-on common channels while maintaining the ability to provide system information when requested by authorized UEs.

Additionally, or alternatively, the NE 1200 may be configured to support any one or combination of the at least one processor is further configured to cause the NE to transmit a configuration for the uplink wake-up signal together with cell selection information and cell access related information to restrict transmission of the wake-up signal to UEs associated with the PLMN of the NE. This aspect prevents unauthorized wake-up signal transmissions from random UEs by requiring completion of cell selection and PLMN verification procedures before wake-up signal authorization, thereby preserving energy savings objectives and preventing interference from non-associated devices.

Additionally, or alternatively, the NE 1200 may be configured to support any one or combination of the first and second carriers are the same carrier configured for a network energy savings mode with reduced transmission frequency, where the at least one processor is further configured to cause the NE to transmit, using the low power radio, at least one paging message during one or more low power paging occasions, where the one or more low power paging occasions are associated with the uplink wake-up signal, and receive, in response to the at least one paging message, a request for the second portion of the minimum system information, where the request for the second portion of the minimum system information is included in one of the uplink wake-up signal or a random access channel message. This aspect achieves maximum energy savings by utilizing a single carrier for all low power operations while maintaining on-demand system information delivery capabilities through coordinated paging and wake-up signal procedures.

Additionally, or alternatively, the NE 1200 may be configured to support any one or combination of the first carrier is configured for periodic frequent common signal transmission and the second carrier is configured for a network energy savings mode with reduced transmission frequency, where the at least one processor is further configured to cause the NE to transmit, using the low power radio, at least one paging message via the second carrier during one or more low power paging occasions, and receive a RACH message via the first carrier based at least in part on the at least one paging message. This aspect enables flexible deployment scenarios by providing reliable initial access through always-on carriers while achieving energy savings through dedicated low power carriers for paging and wake-up procedures.

Additionally, or alternatively, the NE 1200 may be configured to support any one or combination of the uplink wake-up signal is received via the second carrier and indicates at least one of reselection of the UE to the second carrier or a request for the second portion of the minimum system information. This aspect optimizes carrier utilization by enabling UEs to signal both carrier reselection and system information requests through a single wake-up signal transmission, reducing signaling overhead while maintaining energy-efficient operation.

Additionally, or alternatively, the NE 1200 may be configured to support any one or combination of the first carrier is configured for a network energy savings mode with reduced transmission frequency and the second carrier is configured for periodic frequent common signal transmission, where the at least one processor is further configured to cause the NE to transmit, using the low power radio, at least one paging message via the second carrier during one or more low power paging occasions, and receive a RACH message via the second carrier based at least in part on the at least one paging message. This aspect provides enhanced coverage scenarios by utilizing energy-saving carriers for initial access while maintaining reliable connection establishment through always-on carriers for subsequent data communication procedures.

Additionally, or alternatively, the NE 1200 may be configured to support any one or combination of the first portion of minimum system information includes a plurality of information segments transmitted according to orthogonal sequence selection, where each information segment has a respective transmission periodicity. This aspect reduces decoding complexity at UE receivers while enabling flexible power management by transmitting time-sensitive information more frequently than static configuration parameters.

Additionally, or alternatively, the NE 1200 may be configured to support any one or combination of the plurality of information segments includes at least a first information segment including at least one of a cell barred indication, an SSB subcarrier offset parameter, or system frame number information, and a second information segment including at least one of cell selection information, cell access related information, or uplink wake-up signal configuration parameters. This aspect optimizes power consumption and access latency by prioritizing transmission of essential access control information while providing comprehensive system information through segmented delivery.

Additionally, or alternatively, the NE 1200 may be configured to support any one or combination of to transmit the one or more synchronization signals, the at least one processor is further configured to cause the NE to transmit a first stage synchronization signal on a sparse frequency raster using the low power radio, and transmit a second stage synchronization signal using the main radio in response to the uplink wake-up signal. This aspect reduces UE power consumption during cell search procedures by minimizing the number of frequency positions that must be monitored while enabling on-demand delivery of complete synchronization information.

Additionally, or alternatively, the NE 1200 may be configured to support any one or combination of the first stage synchronization signal comprises a primary synchronization signal and the second stage synchronization signal comprises a secondary synchronization signal and a physical broadcast channel. This aspect enables independent power management of synchronization functions by separating basic cell detection from complete system information delivery, allowing network energy savings while maintaining UE synchronization capabilities.

Additionally, or alternatively, the NE 1200 may be configured to support any one or combination of the first stage synchronization signal indicates presence of the second stage synchronization signal and uses a sequence that indicates a cluster of frequency positions for monitoring the second stage synchronization signal, and the second stage synchronization signal comprises a primary synchronization signal, a secondary synchronization signal, and a physical broadcast channel. This aspect provides enhanced flexibility in synchronization signal deployment by enabling dedicated first stage signals that guide UEs to appropriate frequency clusters for complete synchronization signal reception.

Additionally, or alternatively, the NE 1200 may be configured to support any one or combination of the one or more synchronization signals are scrambled with public land mobile network identification information using scrambling sequences derived from the PLMN identification information. This aspect provides network-specific synchronization signals that prevent unauthorized wake-up signal transmissions from UEs belonging to different network operators while maintaining correlation properties needed for reliable synchronization and cell identification procedures.

The controller 1206 may manage input and output signals for the NE 1200. The controller 1206 may also manage peripherals not integrated into the NE 1200. In some implementations, the controller 1206 may utilize an operating system such as iOS®, ANDROID®, WINDOWS®, or other operating systems. In some implementations, the controller 1206 may be implemented as part of the processor 1202.

In some implementations, the NE 1200 may include at least one transceiver 1208. In some other implementations, the NE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas to receive a signal over the air or wireless medium. The receiver chain 1210 may include at least one amplifier (e.g., an LNA) configured to amplify the received signal. The receiver chain 1210 may include at least one demodulator configured to demodulate the receive signal and obtain the transmitted data by reversing the modulation technique applied during transmission of the signal. The receiver chain 1210 may include at least one decoder for decoding the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

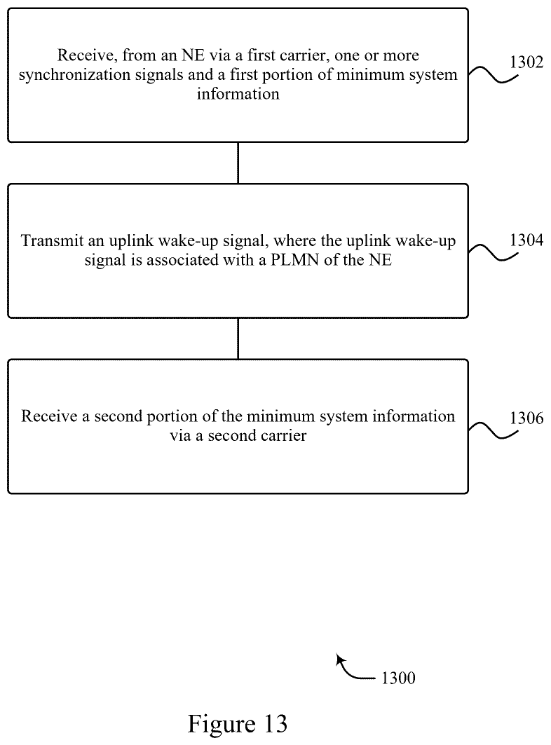

FIG. 13 illustrates a flowchart of a method 1300 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1302, the method may include receiving, from a network entity via a first carrier, one or more synchronization signals and a first portion of minimum system information. The operations of 1302 may be performed in accordance with examples as described herein. In some implementations, aspects of the operations of 1302 may be performed by a UE as described with reference to FIG. 10.

At 1304, the method may include transmitting an uplink wake-up signal, where the uplink wake-up signal is associated with a public land mobile network of the network entity. The operations of 1304 may be performed in accordance with examples as described herein. In some implementations, aspects of the operations of 1304 may be performed by a UE as described with reference to FIG. 10.

At 1306, the method may include receiving a second portion of the minimum system information via a second carrier. The operations of 1306 may be performed in accordance with examples as described herein. In some implementations, aspects of the operations of 1306 may be performed a UE as described with reference to FIG. 10.

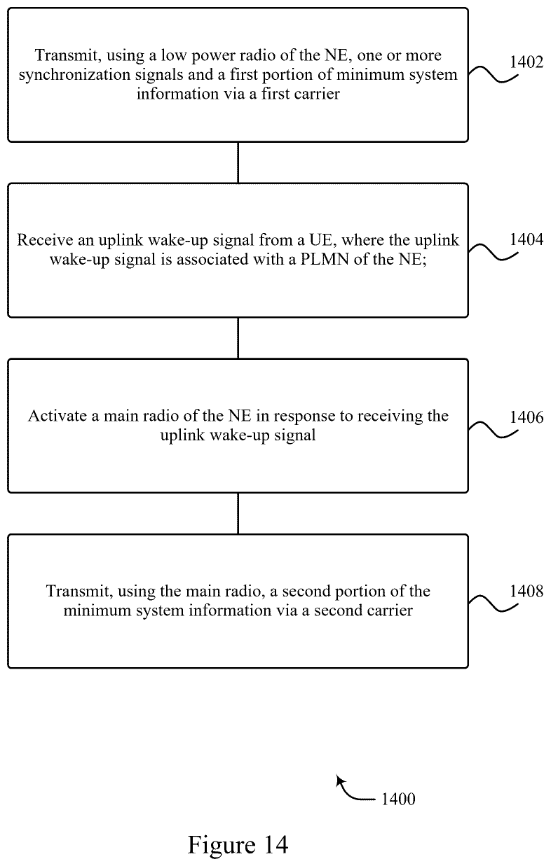

FIG. 14 illustrates a flowchart of a method 1400 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1402, the method may include transmitting, using a low power radio, one or more synchronization signals and a first portion of minimum system information via a first carrier. The operations of 1402 may be performed in accordance with examples as described herein. In some implementations, aspects of the operations of 1402 may be performed by an NE as described with reference to FIG. 12.

At 1404, the method may include receiving an uplink wake-up signal from a user equipment, where the uplink wake-up signal is associated with a public land mobile network of the NE. The operations of 1404 may be performed in accordance with examples as described herein. In some implementations, aspects of the operations of 1404 may be performed by an NE as described with reference to FIG. 12.

At 1406, the method may include activating a main radio of the NE in response to receiving the uplink wake-up signal. The operations of 1406 may be performed in accordance with examples as described herein. In some implementations, aspects of the operations of 1406 may be performed an NE as described with reference to FIG. 12.

At 1408, the method may include transmitting, using the main radio, a second portion of the minimum system information via a second carrier. The operations of 1408 may be performed in accordance with examples as described herein. In some implementations, aspects of the operations of 1408 may be performed an NE as described with reference to FIG. 12.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity (NE) for wireless communication, comprising:
a low power radio;
a main power radio;
at least one memory; and
at least one processor coupled with the at least one memory and operable to cause the NE to:
transmit, using the low power radio, one or more synchronization signals and a first portion of minimum system information via a first carrier;
receive an uplink wake-up signal from a user equipment (UE), wherein the uplink wake-up signal is associated with a public land mobile network (PLMN) of the NE;
activate the main radio of the NE in response to receiving the uplink wake-up signal; and
transmit, using the main radio, a second portion of the minimum system information via a second carrier.

2. The NE of claim 1, wherein the at least one processor is further configured to cause the NE to transmit a configuration for the uplink wake-up signal together with cell selection information and cell access related information to restrict transmission of the wake-up signal to UEs associated with the PLMN of the NE.

3. The NE of claim 1, wherein the first and second carriers are the same carrier configured for a network energy savings mode with reduced transmission frequency, wherein the at least one processor is further configured to cause the NE to:
transmit, using the low power radio, at least one paging message during one or more low power paging occasions (LP-POs), wherein the one or more LP-POs are associated with the uplink wake-up signal; and
receive, in response to the at least one paging message, a request for the second portion of the minimum system information, wherein the request for the second portion of the minimum system information is included in one of the uplink wake-up signal or a random access channel (RACH) message.

4. The NE of claim 1, wherein the first carrier is configured for periodic frequent common signal transmission and the second carrier is configured for a network energy savings mode with reduced transmission frequency, wherein the at least one processor is further configured to cause the NE to:
transmit, using the low power radio, at least one paging message via the second carrier during one or more low power paging occasions (LP-POs); and
receiving a RACH message via the first carrier based at least in part on the at least one paging message.

5. The NE of claim 4, wherein the uplink wake-up signal is received via the second carrier and indicates at least one of reselection of the UE to the second carrier or a request for the second portion of the minimum system information.

6. The NE of claim 1, wherein the first carrier is configured for a network energy savings mode with reduced transmission frequency and the second carrier is configured for periodic frequent common signal transmission, wherein the at least one processor is further configured to cause the NE to:
transmit, using the low power radio, at least one paging message via the second carrier during one or more low power paging occasions (LP-POs); and
receive a RACH message via the second carrier based at least in part on the at least one paging message.

7. The NE of claim 1, wherein the first portion of minimum system information includes a plurality of information segments transmitted according to orthogonal sequence selection, wherein each information segment has a respective transmission periodicity.

8. The NE of claim 7, wherein the plurality of information segments includes at least:
a first information segment including at least one of a cell barred indication, an SSB subcarrier offset parameter, or system frame number information; and
a second information segment including at least one of cell selection information, cell access related information, or uplink wake-up signal configuration parameters.

9. The NE of claim 1, wherein, to transmit the one or more synchronization signals, the at least one processor is further configured to cause the NE to:
transmit a first stage synchronization signal on a sparse frequency raster using the low power radio; and
transmit a second stage synchronization signal using the main radio in response to the uplink wake-up signal.

10. The NE of claim 9, wherein the first stage synchronization signal comprises a primary synchronization signal (PSS) and the second stage synchronization signal comprises a secondary synchronization signal (SSS) and a physical broadcast channel (PBCH).

11. The NE of claim 9, wherein:
the first stage synchronization signal indicates presence of the second stage synchronization signal and uses a sequence that indicates a cluster of frequency positions for monitoring the second stage synchronization signal, and
the second stage synchronization signal comprises a primary synchronization signal (PSS), a secondary synchronization signal (SSS), and a physical broadcast channel (PBCH).

12. The NE of claim 1, wherein the one or more synchronization signals are scrambled with public land mobile network (PLMN) identification information using scrambling sequences derived from the PLMN identification information.

13. A user equipment (UE) for wireless communication, comprising:
a low power radio;
a main power radio;
at least one memory; and
at least one processor coupled with the at least one memory and operable to cause the UE to:
receive, from a network entity (NE) via a first carrier, one or more synchronization signals and a first portion of minimum system information;
transmit an uplink wake-up signal, wherein the uplink wake-up signal is associated with a public land mobile network (PLMN) of the NE; and
receive a second portion of the minimum system information via a second carrier.

14. The UE of claim 13, wherein the at least one processor is further configured to cause the UE to receive a configuration for the uplink wake-up signal together with cell selection information and cell access related information.

15. The UE of claim 13, wherein:
the first and second carriers are the same carrier configured for a network energy savings mode with reduced transmission frequency,
the synchronization signals and the first portion of minimum system information are received using the low power radio, and
the at least one processor is further configured to cause the UE to:
monitor, using the low power radio, for at least one paging message during one or more low power paging occasions (LP-POs), wherein the one or more LP-POs are associated with the uplink wake-up signal;
in response to successful reception of the at least one paging message, transmit a request for the second portion of the minimum system information, wherein the request for the second portion of the minimum system information is included in one of the uplink wake-up signal or a random access channel (RACH) message; and
activate the main radio based at least in part on transmitting the uplink wake-up signal, wherein the second portion of minimum system information is received using the main radio.

16. The UE of claim 13, wherein:
the first carrier is configured for periodic frequent common signal transmission and the second carrier is configured for a network energy savings mode with reduced transmission frequency;
the synchronization signals and first portion of minimum system information are received using the main radio, and
the uplink wake-up signal is transmitted via the second carrier using the main radio of the UE to indicate reselection of the UE to the second carrier.

17. The UE of claim 16, wherein the at least one processor is further configured to cause the UE to:
monitor the second carrier for at least one paging message during one or more low power paging occasions (LP-POs) using the low power radio, wherein the one or more LP-POs are associated with the uplink wake-up signal; and
in response to successful reception of the at least one paging message, transmit a RACH message via the first carrier using the low power radio.

18. The UE of claim 13, wherein:
the first carrier is configured for network energy savings mode with reduced transmission frequency and the second carrier is configured for periodic frequent common signal transmission,
the synchronization signals and the first portion of minimum system information are received using the low power radio, and
the at least one processor is further configured to cause the UE to:
monitor the second carrier for at least one paging message during one or more low power paging occasions (LP-POs) using the low power radio, wherein the one or more LP-POs are associated with the uplink wake-up signal; and
in response to successful reception of the at least one paging message, transmitting a RACH message via the second carrier using the main radio.

19. A method performed by a user equipment (UE), the method comprising:
receiving, from a network entity (NE) via a first carrier, one or more synchronization signals and a first portion of minimum system information;
transmitting an uplink wake-up signal, wherein the uplink wake-up signal is associated with a public land mobile network (PLMN) of the NE; and
receiving a second portion of the minimum system information via a second carrier.

20. A method performed by network entity (NE), the method comprising:
transmitting, using a low power radio, one or more synchronization signals and a first portion of minimum system information via a first carrier;
receiving an uplink wake-up signal from a user equipment (UE), wherein the uplink wake-up signal is associated with a public land mobile network (PLMN) of the NE;
activating a main radio of the NE in response to receiving the uplink wake-up signal; and
transmitting, using the main radio, a second portion of the minimum system information via a second carrier.
